(19) United States
(12) Patent Application Publication
(10) Pub. No.: US 2024/0394758 A1
(43) Pub. Date: Nov. 28, 2024

(54) SYSTEMS AND METHODS FOR ADVANCED HOME MONITORING

(71) Applicant: State Farm Mutual Automobile Insurance Company, Bloomington, IL (US)

(72) Inventors: Kami Lavallier, Pekin, IL (US); Cara B. Shoup, Mesa, AZ (US); Michael J. Maier, Phoenix, AZ (US)

(21) Appl. No.: 18/674,205

(22) Filed: May 24, 2024

Related U.S. Application Data
(60) Provisional application No. 63/592,844, filed on Oct. 24, 2023.
(60) Provisional application No. 63/468,977, filed on May 25, 2023.

(51) Int. Cl. G06Q 30/02

(52) U.S. Cl. CPC G06Q 30/0278

(57) ABSTRACT

Smart home-related technology is provided. A computer system is programmed to: a) receive a first element of home data from the home controller; b) determine a safety score for the residential property based at least in part on the first element of home data; c) receive a first element of external data from the one or more external data sources, the first element of external data relating to a geographical region of the residential property; d) determine a home health score for the residential property; e) determine at least one product provider and service provider to be able to improve the home health score based at least in part upon the first element of home data and the first element of external data; and/or f) cause to be displayed information about the at least one product provider and service provider to improve the home health score.

### CROSS-REFERENCE TO RELATED APPLICATIONS

This application claims priority to U.S. Provisional Patent Application No. 63/592,844, filed Oct. 24, 2023, and to U.S. Provisional Patent Application No. 63/468,977, filed May 25, 2023, the entire contents and disclosures of which are hereby incorporated herein by reference in their entirety.

### FIELD OF THE DISCLOSURE

The field of the invention relates generally to home monitoring systems, and more specifically, to a network-based computer system and method for monitoring attributes of a home and/or vehicle to control systems of the home and/or vehicle and to provide solutions for conditions of the home and/or vehicle.

### BACKGROUND

Numerous risks may exist for the residential homeowner, from acts of nature such as flooding, lightning, tornados, or hurricanes, to electrical fires caused by failing appliances or electrical connections, to home security risks such as theft or vandalism. Many of these risks may be present due to inherent factors not easily controlled or mitigated by the homeowner, but some risks may be addressed by the homeowner. Homeowners may be able to reduce risk by performing certain mitigating actions, but homeowners may often be unaware of many risks and what corrective actions they could take. For example, fire can be caused in the home due to a failing electrical connection causing electricity to arc across a small air gap, thereby leading to extra resistance and heat generated at the point of the failure. However, such problems may be difficult for the homeowner to detect and avoid.

Additionally, homeowners might not be aware of resources available to address those problems when discovered. For example, homeowners may be new to the area and not aware of a trustworthy plumber to call when their basement begins flooding on a Sunday night. Or a homeowner may not be aware of who could help them with waterproofing their basement after the crisis has passed.

What is needed is a system for detecting risks to home health and/or vehicle health, and providing suggestions of various protections and remediation resources for such risks. What is further needed is the ability to monitor, detect and address issues relating to home and/or vehicle health from a single centralized app so that it is convenient for the homeowner to use. Conventional techniques may include additional inefficiencies, encumbrances, ineffectiveness, and/or other drawbacks as well.

### BRIEF DESCRIPTION

The present embodiments may relate to, inter alia, systems and methods for evaluating and mitigating aspects of a residential property. The system may include a remote system server, a home controller, a marketplace (such as a virtual or digital marketplace) server, and one or more smart devices installed within the residential property. The home controller may be installed within the residential property, and may be configured to receive home data from the one or more smart devices via a home network. The home data may reflect an aspect of operational quality of one or more assets of the residential property.

In one aspect, the remote system server may be configured to communicate with the home controller and one or more external data sources outside the residential property via an external network. The remote system server may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the remote system server may include one or more processors and/or associated transceivers programmed to: (i) receive a first element of home data from the home controller; (ii) determine a safety score for the residential property based at least in part on the first element of home data, the safety score representing a measure of safety of the residential property; (iii) receive a first element of external data from the one or more external data sources, the first element of external data relating to a geographical region of the residential property; (iv) determine a home health score for the residential property based at least in part on one or more of the first element of home data provided by the one or more smart devices and the first element of external data from the one or more external data sources, the home health score representing a measure of health of the residential property; (v) determine at least one product provider and service provider to be able to improve the home health score based at least in part upon the first element of home data and the first element of external data; and/or (vi) cause to be displayed, to a homeowner of the residential property via a graphical user interface, information about the at least one product provider and service provider to improve the home health score. The remote system server may have additional, less, or alternate functionality, including that discussed elsewhere herein.

In another aspect, a computing device for evaluating and mitigating aspects of a residential property may be provided. The computing device may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computing device may include at least one processor and/or associated transceiver programmed to: (i) receive a first element of home data from the home controller; (ii) determine a safety score for the residential property based at least in part on the first element of home data, the safety score representing a measure of safety of the residential property; (iii) receive a first element of external data from the one or more external data sources, the first element of external data relating to a geographical region of the residential property; (iv) determine a home health score for the residential property based at least in part on one or more of the first element of home data provided by the one or more smart devices and the first element of external data from the one or more external data sources, the home health score representing a measure of health of the residential property; (v) determine at least one product provider and service provider to be able to improve the home health score based at least in part upon the first element of home data and the first element of external data; and/or (vi) cause to be displayed, to a homeowner of the residential property via a graphical user interface, information about the at least one product provider and service provider to improve the home health score. The computing device may have additional, less, or alternate functionality, including that discussed elsewhere herein.

In yet another aspect, a computer-based or computer-implemented method of evaluating and mitigating aspects of a residential property may be provided. The computer-implemented method may be implemented using one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computer-implemented method may be performed by a computing device including at least one processor and/or associated transceiver. The method may include, via the at least one processor and/or associated transceiver: (i) receiving a first element of home data from a home controller of the residential property; (ii) determining a safety score for the residential property based at least in part on the first element of home data, the safety score representing a measure of safety of the residential property; (iii) receiving a first element of external data from the one or more external data sources, the first element of external data relating to a geographical region of the residential property; (iv) determining a home health score for the residential property based at least in part on one or more of the first element of home data provided by the one or more smart devices and the first element of external data from the one or more external data sources, the home health score representing a measure of health of the residential property; (v) determining at least one product provider and service provider to be able to improve the home health score based at least in part upon the first element of home data and the first element of external data; and/or causing to be displayed, to a homeowner of the residential property via a graphical user interface, information about the at least one product provider and service provider to improve the home health score. The method may have additional, less, or alternate actions, including that discussed elsewhere herein.

In still another aspect, a non-transitory computer readable medium having computer-executable instructions embodied thereon for evaluating aspects of health of a residential property is provided. When executed by at least one processor and/or associated transceiver, the computer-executable instructions cause the at least one processor and/or associated transceiver to: (i) receive a first element of home data from the home controller; (ii) determine a safety score for the residential property based at least in part on the first element of home data, the safety score representing a measure of safety of the residential property; (iii) receive a first element of external data from the one or more external data sources, the first element of external data relating to a geographical region of the residential property; (iv) determine a home health score for the residential property based at least in part on one or more of the first element of home data provided by the one or more smart devices and the first element of external data from the one or more external data sources, the home health score representing a measure of health of the residential property; (v) determine at least one product provider and service provider to be able to improve the home health score based at least in part upon the first element of home data and the first element of external data; and/or (vi) cause to be displayed, to a homeowner of the residential property via a graphical user interface, information about the at least one product provider and service provider to improve the home health score. The computer readable medium may have instructions that direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an exemplary home monitoring and analysis (HMA) system of monitoring and analyzing homes, in accordance with at least one embodiment of this disclosure.

FIG. 2 illustrates an expanded home monitoring and analysis system (“HMA”) that may be used for evaluating a home and the risks associated with a residential house and providing solutions to mitigate those risks, in accordance with the present disclosure.

FIG. 3 illustrates an exemplary high level block diagram of a connected home ecosystem that includes the home, the home monitoring and analysis (HMA) application, and the marketplace.

FIG. 4 illustrates an exemplary data flow diagram of a connected home ecosystem platform in one embodiment of the present disclosure.

FIG. 5 depicts a flow chart of an exemplary computer-implemented process for evaluating and mitigating aspects of a residential property shown in FIG. 1 using the systems shown in FIGS. 1, 2, and 3.

FIG. 6 illustrates an exemplary user interface displaying a home health score for a home shown in FIG. 1 using the connected home ecosystem shown in FIG. 3 and the HMA systems (shown in FIGS. 1 and 2).

FIG. 7 illustrates an exemplary system architecture for the connected home ecosystem shown in FIG. 3 that includes the HMA systems shown in FIGS. 1 and 2.

FIG. 8 illustrates exemplary source devices that may be used with the HMA systems shown in FIGS. 1 and 2.

FIG. 9 illustrates an exemplary computer system for implementing the home monitoring and analysis (HMA) systems shown in FIGS. 1 and 2 performing the process shown in FIG. 5.

FIG. 10 depicts an exemplary configuration of a client computer device shown in FIGS. 1, 2, 4 and 9, in accordance with one embodiment of the present disclosure.

FIG. 11 depicts an exemplary configuration of a server shown in FIG. 1, in accordance with one embodiment of the present disclosure.

FIG. 12A illustrates an exemplary user interface displaying a login page for a connected home ecosystem application.

FIG. 12B illustrates an exemplary user interface displaying a screenshot of a profile builder page for the connected home ecosystem application.

FIGS. 13A, 13B, and 13C illustrate an exemplary user interface displaying screenshots of a personalize section of the profile builder pages for the connected home ecosystem application.

FIGS. 14A, 14B, and 14C illustrate an exemplary user interface displaying screenshots of a property details section of the profile builder pages for the connected home ecosystem application.

FIGS. 15A, 15B, 15C, and 15D illustrate an exemplary user interface displaying screenshots of a home inventory section of the profile builder pages for the connected home ecosystem application.

FIGS. 16A, 16B, and 16C illustrate an exemplary user interface displaying screenshots of a connected devices section of the profile builder pages for the connected home ecosystem application.

FIG. 17A illustrates an exemplary screenshot with options for a user to select to view a score, view recommendations, and/or access a home manager pages for the connected home ecosystem application.

FIG. 17B illustrates an exemplary score report for the pages for the connected home ecosystem application.

FIG. 17C illustrates exemplary access provided to deeper levels or subcategories of the report, and may provide the user with additional details and insights.

FIG. 17D illustrates exemplary personalized recommendations from the score breakdowns, as well as providing improvement recommendations.

FIG. 17E illustrates an exemplary online or digital marketplace, where the user may view vendors and/or solutions to implement those recommendations.

FIG. 18A illustrates an exemplary screenshot for a profile overview for the connected home ecosystem application.

FIGS. 18B and 18C illustrate exemplary screenshots of profile views of a completed profile for the connected home ecosystem application.

FIG. 19A illustrates an exemplary screenshot of intelligent recommendations for the connected home ecosystem application.

FIGS. 19B, 19C, 19D, and 19E illustrate various exemplary recommendations that may be displayed within the connected home ecosystem application.

FIG. 19F illustrates an exemplary earned badge that may be displayed within the connected home ecosystem application.

FIG. 20A illustrates an exemplary screenshot of a notifications page for the connected home ecosystem application.

FIG. 20B illustrates an exemplary weather alert provided by the connected home ecosystem application.

FIG. 20C illustrates an exemplary maintenance due alert, informing the user that the HVAC filters need to be replaced.

FIG. 20D illustrates an exemplary marketplace where the user may buy the HVAC filters that need to be replaced.

FIGS. 20E and 20F illustrate an exemplary home emergency detected alert.

FIGS. 21A and 21B illustrate screenshots of exemplary personalized recommendations provided by the connected home ecosystem application based on the user's information.

FIG. 22 illustrates an exemplary screenshot of a community page that provides the user access to one or more community features of the connected home ecosystem application.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, network-based computer systems and methods for monitoring attributes of a home and/or vehicle to determine and provide solutions for conditions of the home and/or vehicle. As used herein, residential housing or home may mean a house, a condominium, an apartment, or any other property that may include a structure that can be used for shelter. In one exemplary embodiment, a home monitoring and analysis (HMA) system coordinates a connected home ecosystem. The connected home ecosystem includes the home monitoring and analysis system including a multi-sided marketplace for residential products and insights. The connected home ecosystem is configured to bring together customers with third parties offering smart home products, home-related services, and home insights. The home monitoring and analysis system acts as the orchestrator of this connected home ecosystem. The home monitoring and analysis system may be configured to derive unique insights via artificial intelligence/machine learning (AI/ML) tools. The home monitoring and analysis system is configured to build and provide deep individual risk understanding, prediction, and mitigation capabilities to the connected home ecosystem.

In the exemplary embodiments, the HMA server provides a single application platform for users to integrate their access to multiple different systems and services. These systems and services may include, but are not limited to, insurance services, financial services, home monitoring services, such as Ting and ADT, sprinkler controllers, home thermostat controllers, Wi-Fi control, automobile control (e.g., current charge amount), lighting controllers, and/or other controllers, services, and/or monitors available to users. The HMA server coordinates communications with these controllers, services, and/or monitors to allow the user to have a single point of access. The HMA service provides the HMA application that provides a simplified experience while bringing visibility to other benefits and/or services available through the HMA application. The HMA application allows the user to view and control all aspects of their home and home related services from one place. This also allows the HMA server to know which devices the user has connected and then to provide customer tips about how to improve home security, efficiency, and/or loss mitigation opportunities, for example. These tips may include recommendation of products and/or services that provide users with improved home security, efficiency, and/or loss mitigation opportunities. This may allow the HMA server to determine gaps in the user's protection (physical, financial, insurance, etc.) and provide recommendations to rectify the deficiencies. In some embodiments, the HMA application may incentivize users to share data with the HMA server through rewards and/or premium discounts on one or more provided services.

The home monitoring and analysis (HMA) system collects home data about the home, which may include home health data. Home health data may include various types of data that may impact home health or may reflect risks to the house, such as from acts of nature (e.g., weather, seismic activity, flooding, or the like) or from man-made risks or other inherent risks to a home (e.g., electrical fires from aging wiring, theft or vandalism of property, aging appliances or heating, ventilation and air conditioning (HVAC), or the like), or other home data that may positively or negatively impact risks to and insurability of the home. The home monitoring and analysis system may also collect data about different attributes of the home, such as, but not limited to, power usage, water usage, current temperatures, doors and/or windows open or closed, as well as current and future weather conditions and other parameters that may affect the home.

The home monitoring and analysis (HMA) system may collect some home data from external sources (e.g., publicly available data, such as historical weather-related information or power outage statistics for the area, emergency service response statistics for the area, or the like) or from home sources (e.g., data gathered from sensors, appliances, IoT devices, or networked devices within and/or around the house). The homeowner/user may also provide the home monitoring and analysis system with access to data from different monitors and other devices in the home, such as Internet of Things (IoT) devices. The IoT devices may provide their data directly and/or provide data through servers associated with and in communication with the IoT devices.

The home monitoring and analysis system may then analyze the provided data to, for example, alert appropriate or registered users of various projected or current risks to the home, discounts for risk mitigating activities, and ongoing historical data collection for ongoing use. As such, subject homes may include a home controller that is configured (e.g., on a home network) to communicate with various sensors, appliances, and other devices within the home and to relay home data to a remote system server for various uses discussed herein.

In one exemplary embodiment, the home monitoring and analysis system may include a home analysis model engine that may capture home data from home sources and provide alerting to the homeowner, or perhaps emergency services (e.g., fire services, police services), when current or impending risks to the home are detected. For example, the home network may be configured with electrical circuit sensors that are configured to monitor electrical circuits within the home to detect various inconsistencies or symptoms of dangerous conditions, such as arcing caused by faulty or separating connections on the circuit. Such arcing conditions can lead to greater resistance and heat generated over time, which may eventually lead to a fire within the house. The home monitoring and analysis engine may regularly evaluate such data and may provide, for example, evaluations of potential risks to the homeowner (e.g., articulating the source and nature of the risk within the home), recommendations to the homeowner for risk mitigation (e.g., detailing how the identified risks may be reduced), or alerting for contemporaneous events detected within the home (e.g., transmitting an alert to a mobile device or nest device of the homeowner upon detection of fire, power outage, nearby lightning strike, network outage). In some embodiments, the home monitoring and analysis system may provide a home health score to the homeowner, which may be used to identify areas of improvement or risk reduction that may impact safety or insurability of the home. As such, the home health system helps identify and mitigate risks to the property of the homeowner and the health and safety of the occupants of the house.

The home monitoring and analysis system may analyze the home data to determine one or more issues with the home to notify the homeowner/user about. For example, these issues may include, but are not limited to, a burst pipe or other plumbing problem, a weather condition, such as hail, a maintenance issue, such as a filter needing replacement, and/or other issues that may need the attention of the homeowner/user.

In one exemplary embodiment, the home monitoring and analysis (HMA) system may include a risk evaluation engine that may evaluate home data from external or home sources to evaluate various risks associated with the home. The HMA system may use numerous data points to evaluate risks to a residential property and may compute a composite risk score or various focused risk scores for the property.

Such risk scores may be used, for example, by an insurance provider, to evaluate insurability of the property and its assets, to price insurance policy options for the property, or to provide policy discounts and verify compliance for risk mitigating changes, actions, or behaviors. For example, the risk evaluation engine may generate a power quality score for the property based upon factors such as, inter alia, the power consumption habits of the house, the number of large electrical devices, the number and duration of historical power outages incurred in the area, the number of power surges detected on circuits within the home, or the age of wiring within the home.

The HMA system may also be in communication with one or more marketplaces that provide access to and matching with companies that provide products and/or services that may improve the home health score and improve the safety of the home. The marketplace may also provide access to and matching with companies to mitigate and/or correct current issues that are currently occurring in the home. One of the goals is to help the consumer to make their home better, safer, and more sustainable, and to help the consumer to more easily connect with parties that are able to help address their needs. Other examples of products and/or services provided by the marketplace include, but are not limited to, plumbers, smart home devices, security systems, maintenance, such as of a HVAC (heating, ventilation, and air conditioning) system, and/or insurance.

The risk evaluation engine may also generate a safety score for the property based upon factors such as, inter alia, a presence or number of ground fault circuit interrupter (“GFCI”) outlets within the home, electrical storm frequency near the home, grounding or arcing issues on circuits within the home, or the presence and activity of a security system within the home. The risk evaluation engine may generate a home health score from the home based upon factors such as, inter alia, the age of appliances within the home, power consumption, various occupant behaviors or demographics, a number of actionable notifications generated by the system, and issue resolution responsiveness. Such scores may be used to evaluate risks, indicating more or less risk to the home and the assets within the home and, as such, may impact pricing of an insurance policy for the home.

In the exemplary embodiment, the HMA server provides the users access to the marketplace, while using ML and AI to determine which product providers and service providers are the most relevant to the user based on the analysis of their home. In at least some embodiments, the HMA server determines different attributes and/or conditions of the home based on the home data provided from the devices and/or the external data sources. The HMA server may use the different attributes and/or conditions of the home to build a digital property profile of the home. Then the HMA server may use the digital property profile and the current home data to determine a home health score. The home health score is an abstraction that provides a value for the current condition of the home based on the aggregate of different attributes and/or conditions of the home. In the exemplary embodiment, the home health score is a mix of characteristics to provide a holistic view regarding the well-being of a home. Elements about the home, as well as the surrounding environment, are taken into consideration as part of the calculation for the home health score. The HMA server may also determine/calculate a home profile score that is an aggregate score displayed to the user, such as through a dashboard, which calculates subcategories of safety and structural risks for a home based on home and external data. The home profile score may be provided through a mobile app that allows a user to search for their home address and see a dynamic “Home Profile Dashboard” that includes a personalized Home Score, Recommendations, and Marketplace.

While various examples provided herein describe application of the HMA system to various aspects of homes, the systems and methods described herein may also be used for performing other analysis, such as vehicles, businesses, municipal locations, and/or other locations and/or items.

Exemplary System for Monitoring and Analyzing Homes and/or Vehicles

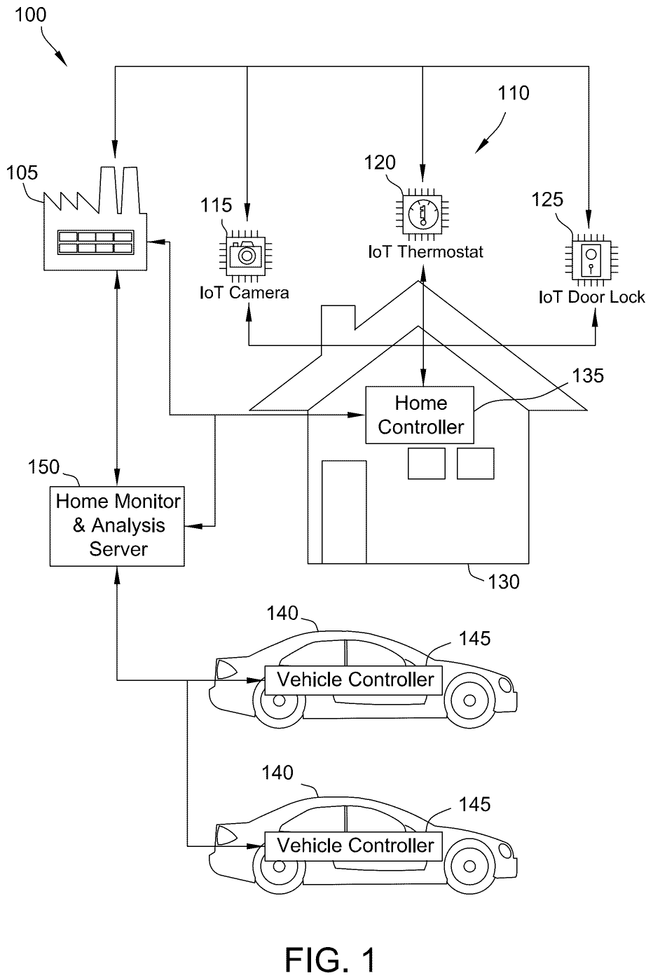

FIG. 1 illustrates an exemplary HMA system 100 of monitoring and analyzing homes, in accordance with at least one embodiment of this disclosure. System 100 illustrates monitoring and other devices to receive, analyze, and report the data collected about the home.

In the exemplary embodiment, a manufacturer 105 provides one or more internet connected devices 110, also known as Internet of Things (IoT) devices 110. These devices 110 may be in or around a home 130. The devices 110 may include, but are not limited to IoT cameras 115, IoT thermostats 120, IoT door locks 125, and/or any other Internet connected device, such as a mobile device, including, but not limited to, a laptop and/or a mobile phone, one or more voice or chat bots, a computer device, including, but not limited to, a desktop computer and/or a router, and/or a home controller 135. In at least one embodiment, the home controller 135 is in wired or wireless communication the one or more devices 110 in the home 130. In some embodiments, the home controller 135 may be a router or Wi-Fi providing device in the home 130. In other embodiments, the home controller 135 is a smart home controller that controls one or more of the devices 110 and may provide communication between the user and the individual devices 110.

In at least one embodiment, each device 110 collects data about the home either directly or indirectly. For example, a smart light bulb may report when the bulb is on and off. This may indirectly indicate whether or not an individual is near the bulb. In the at least one embodiment, many devices 110 are in communication with one or more servers of the manufacturer 105. The manufacturer server 105 may provide additional services, such as remote activation. The manufacturer server 105 may also collect data observed by the device 110, including, but not limited to, usage data about the device 110.

In some embodiments, a home monitoring and analysis (HMA) server 150 may be in communication with one or more of the IoT devices 110, the home controller 135, and/or the manufacturer servers 150. The HMA server 150 collects data from the IoT devices 110 to determine if there are issues with the home. Then the HMA server 150 determines one or more products and/or services that may correct and/or mitigate the issues with the home.

In the exemplary embodiment, vehicles 140 may also have sensors and other information that may be provided to the HMA server 150 for analysis. For example, the HMA server 150 may be in communication with the vehicle controller 145. From the vehicle controller 145, the HMA server 150 may receive information about the condition and operation of the vehicle 140. The HMA server 150 may then determine one or more issues with the vehicle 140 and provide suggestions of one or more goods and/or services to assist with the one or more issues. The HMA server 150 may receive information about the operation of the air conditioning in the vehicle 140 and determine that a filter may be clogged. This may cause the HMA server 150 to suggest that the vehicle 140 is taken in for service and/or provide information about the filter that needs changing so that the user may do it themselves.

### Exemplary Home Monitoring System

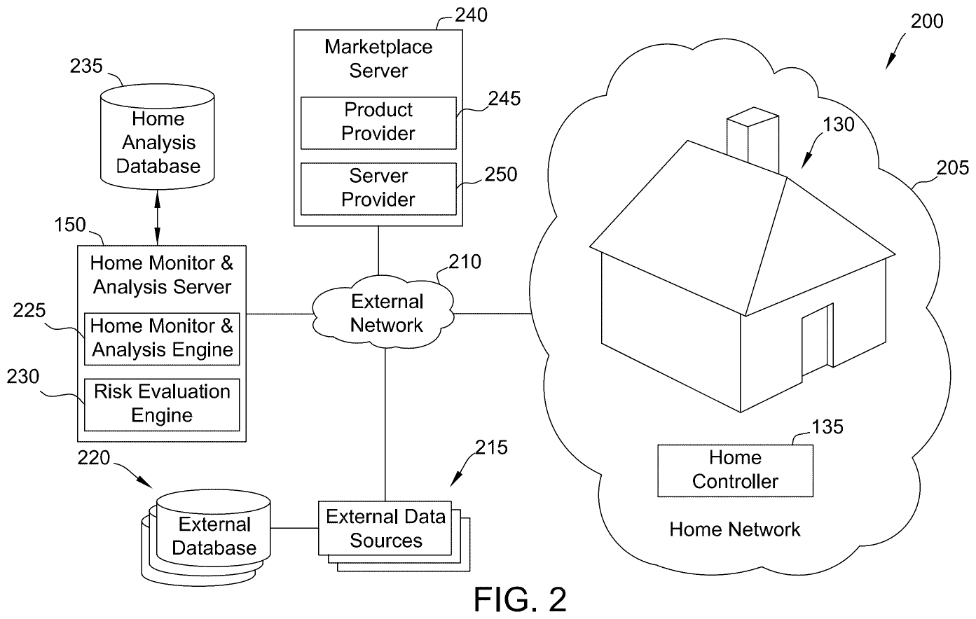

FIG. 2 illustrates an expanded home monitoring and analysis system (“HMA”) 200 that may be used for evaluating a home 130 and the risks associated with a residential house (the home 130) and providing solutions to mitigate those risks, in accordance with the present disclosure. In the exemplary embodiment, the HMA system 200 includes the home monitoring and analysis (HMA) server 150 that may be remote from the home. The HMA server 150 is configured to execute a home monitor and analysis engine 225 and a risk evaluation engine 230. The HMA server 150 may include or otherwise be in communication with a home analysis database 235 that stores information about the house 130 that may be used to evaluate home health and risks, and may include information about real estate upon which the house 130 is located, assets contained within the house 130, and various data points that may influence the various factors of risk described herein. Collectively, this data is referred to herein as “home health data.” Further, the terms “house,” “home,” and “residential property” may be used interchangeably herein to refer to the home 130 and its various property and assets.

In the exemplary embodiment, the HMA server 150 is in networked communication with a home controller (or just “controller”) 135 of the home 130 through an external network 210 (e.g., the Internet). The home controller 135 may manage aspects of home health data collection, computations, and alerting as a part of the home health system 100. The home controller 135 is connected to a home network 205 of the house 130 which allows communication with the HMA server 150 through an external network 210 (e.g., the Internet). For example, the house 130 may include a local area network (“LAN”), a wireless network (e.g., Wi-Fi network), or some combination thereof that connects to the external network 210 (e.g., via a subscription service to an Internet service provider, or the like). In some embodiments, the home controller 135 may communicate via a wireless mobile network, such as a 3G, 4G, or 5G network.

The home network 205 may allow various devices within the home 130 to communicate over the home network 205, such as computing devices and Internet-of-Things (“IoT”) type devices 110 (shown in FIG. 1) (e.g., smart sensors, smart appliances, or the like). Such devices 110 may be referred to herein as “home devices,” in that they are associated with the home 130 or otherwise a part of the home network 205. Some home devices 110 may participate in the HMA system 100 and/or the HMA system 200, for example, providing home data that may be used (e.g., by the remote system server 150) to evaluate home health, to generate risk scores, determine matches in the marketplace 240, or other uses described herein.

In the exemplary embodiment, the systems 100 and 200 may allow homeowners to opt into or out of various aspects of data collection from home devices 110 (e.g., by device type, by type of data collected, by data use). For example, the homeowner may be presented with an individual login to the system 100 and 200 which may include an opt-in screen that allows the homeowner to view data collection and usage policy and select whether they wish to allow such usage, thereby protecting privacy of the homeowner. Home data generated by such devices 110 may be referred to herein as just “home data.”

The HMA server 150, in the exemplary embodiment, may collect some home data from one or more external data sources 215. The home monitor and analysis engine 225 or the risk evaluation engine 230 may, for example, collect data from publicly available sources or from private third-party sources about the particular subject home 130 or the area in which the home 130 is built (referred to herein as “the locality of the home”). For example, one external data source 215 may be the national weather service (“NWS”), a branch of the national oceanic and atmospheric administration (“NOAA”). The NWS collects, and makes publicly available, weather data for the United States of America and its outlying countries.

The system 100 and 200 may collect aspects of historical, current, or predictive weather data for a locality of the home 130 (e.g., storm, wind, lightning, flooding in the locality) and may use such data to evaluate aspects of home health and risk. Such data from external data sources 215 is referred to herein as “external home health data,” or just “external data.” Some external data sources 215 may maintain such external data in one or more external databases 220. Other examples of external data sources 215 and external data may be provided by manufacturers 105 (shown in FIG. 1) in addition to those provided below, as well as various uses for such external data.

In the exemplary embodiment, the HMA server 150 is in communication with a marketplace server 240 through the external network 210. The marketplace server 240 is a platform where businesses come together to sell products and services to the customer base of homeowners. The marketplace server 240 and the HMA server 150 determine the needs of the users and then determines which product providers 245 and service providers 250 that may be of assistance to the user.

In the exemplary embodiment, the HMA server 150 may be operated by an insurance provider that provides insurance coverage for the home 130 (e.g., via a home insurance policy) or that provides participation in systems 100 and 200 as a home protection service for the homeowner. The insurance provider may be any individual, group of individuals, company, corporation, or other type of entity that may issue insurance policies for customers, such as a homeowners, renters, or personal articles insurance policy associated with the home 130 or an insured. For example, after signing up for a home insurance coverage, the insurance provider may provide the home controller 135 for installation in the home 130.

Although the present disclosure describes the systems and methods as being facilitated in part by the insurance provider, it should be appreciated that other non-insurance related entities may implement the systems and methods. For example, a general contractor may aggregate the insurance-risk data across many properties to determine which appliances or products provide the best protection against specific causes of loss, or deploy the appliances or products based upon where causes of loss are most likely to occur. Accordingly, it may not be necessary for the home 130 to have an associated insurance policy for the property owners to enjoy the benefits of the systems and methods.

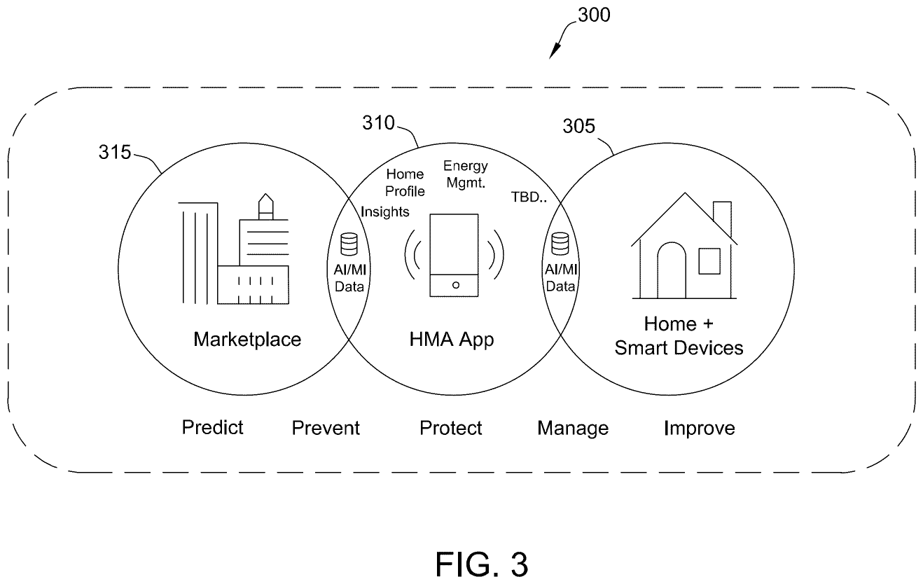

The home controller 135, as discussed in greater detail below, may be configured to monitor aspects of home health, collect home data from sensors, appliances, or other devices within the home 130, connect to the home network 205, and communicate with the HMA server 150 and/or marketplace server 240 for the various aspects of home health services and risk evaluation described herein. The home controller 135 may be configured to connect to the home network 205 and communicate with other networked devices 110 (or “smart devices”) within the home 130. Such devices 110 may be referred to herein as “source devices,” “connected devices,” or “IoT devices,” as devices that provide home data to the systems 100 and 200. In some embodiments, the HMA server 150 may communicate directly some or all of the source devices 110 within the home 130. Various source devices are illustrated in further detail below with respect to FIG. 3.

In the exemplary embodiment, the HMA server 150 provides the users access to the marketplace, while using ML and AI to determine which product providers 245 and service providers 250 are the most relevant to the user based on the analysis of their home. In at least some embodiments, the HMA server 150 determines different attributes and/or conditions of the home based on the home data provided from the devices 110 and/or the external data sources 215. The HMA server 150 may use the different attributes and/or conditions of the home to build a digital property profile of the home. Then the HMA server 150 may use the digital property profile and the current home data to determine a home health score. The home health score is an abstraction that provides a value for the current condition of the home based on the aggregate of different attributes and/or conditions of the home. In the exemplary embodiment, the home health score is a mix of characteristics to provide a holistic view regarding the well-being of a home. Elements about the home, as well as the surrounding environment, are taken into consideration as part of the calculation for the home health score. The HMA server 150 may also determine/calculate a home profile score that is an aggregate score displayed to the user, such as through a dashboard, which calculates subcategories of safety and structural risks for a home based on home and external data. The home profile score may be provided through a mobile app that allows a user to search for their home address and see a dynamic “Home Profile Dashboard” that includes a personalized Home Score, Recommendations, and Marketplace.

### Exemplary Home Ecosystem

FIG. 3 illustrates an exemplary high level block diagram of a connected home ecosystem 300 that includes the home 305, the home monitoring and analysis (HMA) application 310, and the marketplace 240. The connected home ecosystem 300 provides consumers a suite of residential products and services from multiple companies, along with curated insights made possible by sophisticated AI and machine learning (ML) models powered by rich data sources. The connected home ecosystem 300 helps consumers to make their home 305 better, safer, and more sustainable.

The marketplace 315 is a platform where businesses come together to sell products and services to a curated customer base. It matches potential buyers of a service or a product with providers of that service or product. In some embodiments, the marketplace 315 is associated with and/or connected to the marketplace server 240 (shown in FIG. 2).

The HMA app 310 refers to a mobile application that the user downloads and uses to interact with the connected home ecosystem 300. The mobile app 310 contains a home screen, account management, and navigation to all capabilities. In the exemplary embodiment, the HMA app 310 is in communication with or a part of the HMA server 150 (shown in FIG. 1). The HMA server 150 provides information to and receives information from the HMA app 310.

The home 305 refers to the physical home 130 where the consumer resides. This includes smart devices 110 (both shown in FIG. 1) within the home 130 having the ability to provide data to the connected home ecosystem 300. In the example embodiment, a B2B data sharing agreement may be in place to enable this activity.

In some embodiments, the HMA app 310 and server 150 act as an interface between the home 305 and the marketplace 315.

### Exemplary Home Ecosystem Platform

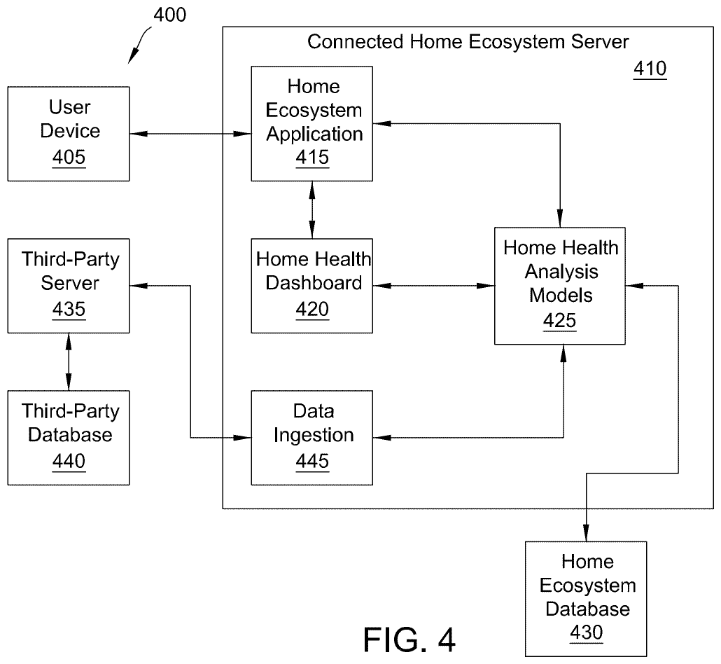

FIG. 4 illustrates an exemplary data flow diagram of a connected home ecosystem platform 400 in one embodiment of the present disclosure.

In the exemplary embodiment, a plurality of user devices 405 are in communication with a connected home ecosystem platform 415. The plurality of user devices 405 are associated with at plurality of users who are users of the connected home ecosystem application 415, also known as the HMA application 310 (shown in FIG. 3). The connected home ecosystem server 410 provides access the home ecosystem application 415 to the plurality of user devices 405. In some embodiments, the connected home ecosystem server 410 is associated with and/or in communication with the HMA server 150 (shown in FIG. 1).

The home ecosystem application 415 may provide analysis of the user's home 130 (shown in FIG. 1) to the user. In the exemplary embodiment, the home ecosystem application 415 may provide a dashboard 420 to the user to provide a quick overview of the current status of the user's home 130. The dashboard 420 may be provided by a home health dashboard module 420 executed by the connected home ecosystem servers 410. The home ecosystem application 415 and the home health dashboard 420 are in communication with one or more home health analysis models 425. The home health analysis models 425 include artificial intelligence (AI) models to analyze data about the user's home to determine a home health score of the home 130. The home health score represents how safe and protected the home 130 is. In some embodiments, the home health analysis models 425 are associated with and/or executed by the HMA engine 225 and/or the risk evaluation engine 230 (both shown in FIG. 2).

The home health analysis models 425 may also provide recommendations and suggestions of ways to correct any issues detected in their analysis. The home health analysis models 425 use information stored in one or more home ecosystem databases 430, information provided by the user, and/or information provided by one or more third-party servers 435. In some embodiments, the home ecosystem databases 430 may be connected to the connected home ecosystem servers 410. In other embodiments, the home ecosystem databases 430 may be in wireless or wired communication with the connected home ecosystem servers 410. In some embodiments, the home ecosystem databases 430 are similar to the home analysis database 235 (shown in FIG. 2).

The third-party server 435 represents the different external sources of information that the platform 400 may use to make decisions, determine scores, and provide to the user. While only one third-party server 435 is shown in FIG. 4, one having skill in the art would understand that the connected home ecosystem server 410 may be in communication with at a plurality of different third-party servers 435. The third-party servers 435 may be associated with different devices 110 (shown in FIG. 1) and/or services that the user has in the home 130. For example, a third-party server 435 may be associated with a security monitoring company that monitors the home 130. The third-party server 435 may provide information about alerts and other measurements in, and/or characteristics of, the home. The third-party server 435 may be associated with one or more smart appliances 110 in the home 130. In some embodiments, third-party servers 435 may include marketplace servers 240, external data sources 215 (both shown in FIG. 2) and/or manufacturer servers 105 (shown in FIG. 1).

The third-party server 435 may provide monitoring information to the connected home ecosystem server 410. The third-party server 435 may also provide alerts to the connected home ecosystem server 410, such as, that the oven has been on for over four hours. The third-party servers 435 may also be in communication with one or more third-party databases 440 that store information for the third-party servers 435, such as historical monitoring information. In some embodiments, third-party databases 440 may be similar to external databases 220 (shown in FIG. 2).

In the exemplary embodiment, each third-party server 435 may provide information to the connected home ecosystem server 410 through a data ingestion model 445. The data ingestion module 445 may receive data from one or more third-party servers 435. The data ingestion model 445 may convert the data into a standardized format, categorize the data, and then store the data for use with the home health analysis models 425. In the exemplary embodiment, the data ingestion module 445 may store the data in one or more home ecosystem databases 430.

In the exemplary embodiment, the connected home ecosystem 300 is connected to a plurality of sections or subject areas relating to the home 130, where each section further divides and organizes the home 130 to allow the user easy access to the information and a better understanding of what information has been gathered.

### Exemplary Computer-Implemented Method for Monitoring and Updating Client Devices

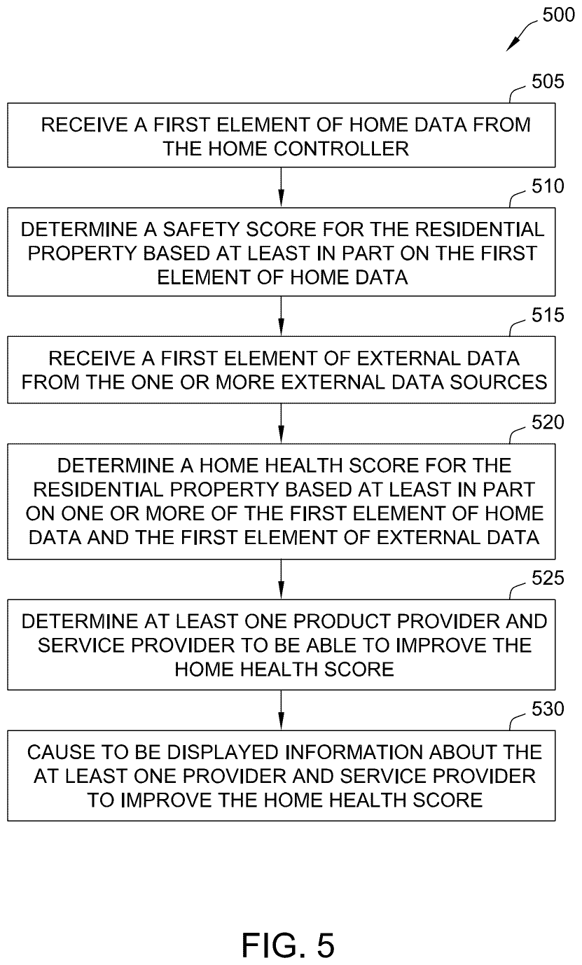

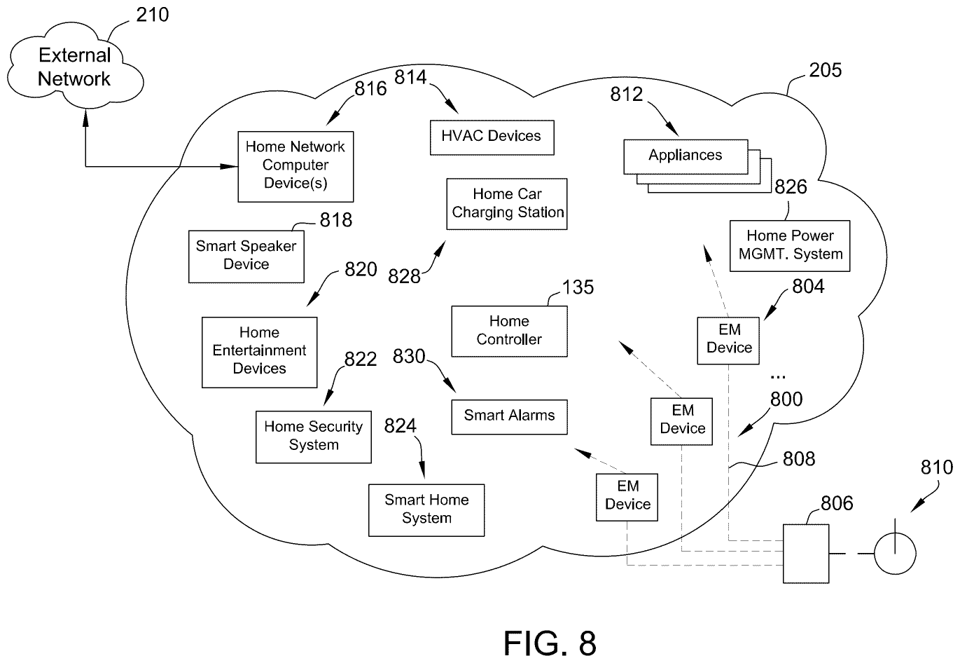

FIG. 5 depicts a flow chart of an exemplary computer-implemented process 500 for evaluating and mitigating aspects of a residential property 130 (shown in FIG. 1) using the systems 100, 200, and 400 (shown in FIGS. 1, 2, and 4). Process 500 may be implemented by a computing device, for example home monitoring and analysis (“HMA”) server 150 (shown in FIG. 1). In the exemplary embodiment, HMA server 150 may be in communication with one or more smart devices 110 installed within the residential property 130, one or more home controllers 135 (all shown in FIG. 1), one or more external data sources 215, one or more marketplace servers 240 (both shown in FIG. 2), one or more user devices 405 (shown in FIG. 8), third-party servers 435, connected home ecosystem server 410, and/or home ecosystem application 415 (all shown in FIG. 4).

In the exemplary embodiment, the HMA server 150 receives 505 a first element of home data from the home controller 135. The home controller may receive the first element of home data from one or more devices 110 on the home network 205 (shown in FIG. 2).

In the exemplary embodiment, the HMA server 150 determines 510 a safety score for the residential property 130 based at least in part on the first element of home data. The safety score represents a measure of safety of the residential property 130.

In the exemplary embodiment, the HMA server 150 receives 515 a first element of external data from the one or more external data sources 215. The first element of external data relating to a geographical region of the residential property 130.

In the exemplary embodiment, the HMA server 150 determines 520 a home health score for the residential property 130 based at least in part on one or more of the first element of home data provided by the one or more smart devices 110 and the first element of external data from the one or more external data sources 215. The home health score represents a measure of health of the residential property 130.

In the exemplary embodiment, the HMA server 150 determines 525 at least one product provider 245 and service provider 250 (both shown in FIG. 2) to be able to improve the home health score based at least in part upon the first element of home data and the first element of external data.

In the exemplary embodiment, the HMA server 150 causes 530 to be displayed, to a homeowner of the residential property 130 via a graphical user interface, information about the at least one product provider 245 and service provider 250 to improve the home health score.

In some embodiments, the HMA server 150 and/or the home controller 135 are in communication with one or more smart devices 110 installed within the residential property 130. In these embodiments, the home controller 135 is configured to receive home data from the one or more smart devices 110 via the home network 205. The one or more smart devices 110 are configured to monitor one or more attributes of the residential property 130. The HMA server 150 may also cause to be displayed, to the homeowner of the residential property 130 via the graphical user interface, information about the one or more attributes of the residential property 130, such as on a user device 405. Furthermore, in some embodiments, the one or more smart devices 110 are configured to control one or more systems of the residential property 130. In these embodiments, the HMA server 135 receives, from a user device 405 of the homeowner of the residential property 130, an instruction for a first smart device 110 of the residential property 130. The HMA server 135 transmits the instruction to the home controller 135. The home controller 135 is configured to transmit the instruction to the first smart device 110 and the first smart device 110 executes the instruction.

In some further embodiments, the home data reflects an aspect of operational quality of one or more assets of the residential property 130.

In still further embodiments, the HMA server 150 generates one or more recommendations to improve the home health score for the residential property 130. The HMA server 150 causes to be displayed, to the homeowner of the residential property 130 via the graphical user interface, the one or more recommendations to improve the home health score for the residential property 130.

In additional embodiments, the HMA server 150 receives an alert from the home controller 135. The HMA server 150 causes to be displayed, to the homeowner of the residential property 130 via the graphical user interface, the alert. In some additional embodiments, the HMA server 150 transmit the alert to a third-party server 435.

### Exemplary User Interface

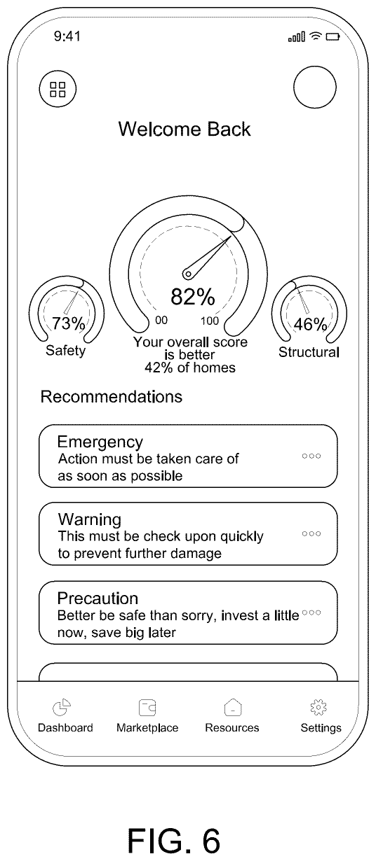

FIG. 6 illustrates an exemplary user interface 600 displaying a home health score for a home 130 (shown in FIG. 1) the connected home ecosystem 300 (shown in FIG. 3) using the HMA systems 100 and 200 (shown in FIGS. 1 and 2). The home health score is derived from a full-featured, data-based view of a property using home data, third party property characteristics data and machine learning based models 425 (shown in FIG. 4). The home health score is a calculation that uses a proprietary mix of characteristics to provide a holistic view regarding the well-being of a home 130. Elements about the home 130, as well as the surrounding environment, are taken into consideration as part of the calculation. An aggregate score may be displayed in the home profile dashboard 420 (shown in FIG. 4) that calculates subcategories of safety and structural risks for a home 130 based on home collected data and external data. A mobile app 415 (shown in FIG. 4) that allows a user to search for their home address and see a dynamic “Home Profile Dashboard” that includes a personalized home score, recommendations, and marketplace 315 (shown in FIG. 3). The user may then drill down on specific elements and details through the dashboard 420.

### Exemplary System Architecture

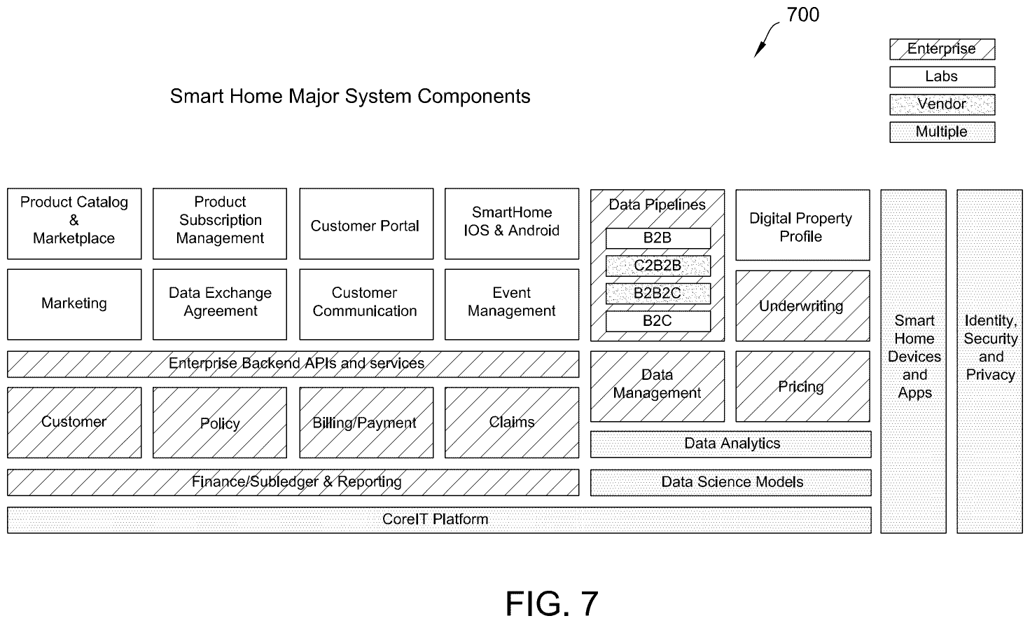

FIG. 7 illustrates an exemplary system architecture 700 for the connected home ecosystem 300 (shown in FIG. 3) that includes the HMA systems 100 and 200 (shown in FIGS. 1 and 2). The exemplary system architecture 700 includes a variety of components that are described below.

The product catalog and marketplace component provides the ability for consumers to access, browse, and learn about the value of connected services in the catalog. This may include a recommender model, such as home health analysis models 425 (shown in FIG. 4). The marketing component includes marketing technology to promote and measure performance of the product acquisition and sales. The product subscription and management component includes the ability to manage subscription agreements with consumers and potentially provide an alternate means of subscription billing and payment, separate from enterprise-level capabilities. The data exchange agreement component includes the ability to bind and maintain semi/standardized agreements for data exchange between multiple parties (consumer/provider) and enables elements of related self-service. In some embodiments, one or more of these components may be executed by and/or associated with the marketplace server 240, the product provider 245, and/or the service provider 250 (all shown in FIG. 2).

The customer portal component (B2B) includes the ability for business consumers and individual consumers to manage their key account attributes. The customer communication component includes multi-channel consumer communications (email, push, SMS, etc.) used to deliver all forms of platform-specific information. The smarthome iOS and Android component includes flagship or stand-alone mobile/digital assets. This includes the primary interaction point for consumer interaction and value. The event management component includes the ability to track and respond to cross-functional events to feed synchronous and asynchronous customer insight communications.

The enterprise backend APIs (application programming interfaces) and services component includes the ability to communicate and integrate with existing required enterprise services. The customer component includes the singular management of multi-product customer and associated attributes. The policy component includes the management of existing insurance-related product agreements. This is required interaction for reference/correlation to existing agreements/policies, types, details, etc. The billing/payment component includes management of billing and payments for products. Required interaction for consolidated billing, payments, discount application, etc. the claims component includes enterprise claim management and related capabilities. Required interaction for reference/correlation to claims, claims history, and related. The finance/subledger and reporting component includes enterprise core financial services.

The plurality of data integration and pipelines component includes the ability to ingest smart home-related data through various patterns. Below describes the back-end data ingestion unless otherwise noted. (1) B2B-Business-to-business data ingestion without direct consumer agreement (e.g., publicly available data such as real-estate, weather, aggregator); (2) C2B2B-Consumer-to-business-to-business where the consumer has a direct agreement with an existing eligible product and chooses to integrate (“connect”) the data to the platform 410 for ongoing use, for example, where existing smart thermostat 120 (shown in FIG. 1) is eligible to participate in the network; (3) B2B2C: Business-to-business-to-consumer provides access to (or sell) a product or sub-platform of products through the platform; and/or (4) B2C-Business-to-consumer provides direct access to (or sell) one or more products on the platform (e.g., distribute low-power, edge-computing smart sensor and ingest data directly through the app 415 (shown in FIG. 4)).

The data management component provides the ability to normalize, manipulate, and store data for broad case uses. The digital property profile component includes existing products to provide insight into home health using additional data sources, such as external data sources 215, external databases 220 (both shown in FIG. 2), third-party database 440, and/or home ecosystem databases 430 (both shown in FIG. 4). The data analytics component includes the ability to derive insight from data using a variety of classical approaches. The data science component includes the ability to leverage contemporary machine learning techniques plus additional related capabilities (e.g., data preparation). The core IT platform component includes cloud-based infrastructure and platform as a server (IaaS, PaaS). The smart home devices 110, apps 415, and platforms 400 component provides an existing ecosystem of devices 110, applications 415, and connected platforms 400 (e.g., Apple Home, Google Home, Amazon Alexa), which provide the primary control plane for a connected home 130. The identity, security, and privacy component includes the ability to manage the individual and aggregate identities and relationship, related to access to data and all other capabilities.

At least one advantage of the system 100 and 200 is the ability to predict, prevent, protect, and manage home events. The connected home ecosystem 300 will lead the industry in providing advanced residential insights. Consumers will receive insights to inform them about activities they can do to help keep their home 130 safer due to events that can be determined by data insights. Examples of insights include, but are not limited to: (i) core insurance offerings; (ii) education and opportunity to purchase smart devices and services that help predict and prevent issues related to perils such as water leaks and fire hazards; (iii) home maintenance notifications such as filters needing to be changed in an HVAC system; (iv) recommendations for having an appliance looked at because operational anomalies are detected through a smart device; and/or (v) notifications and preparedness advice for weather events.

At least one other advantage provided by the connected home ecosystem 300 is to have all of this information in one place. The connected home ecosystem 400 provides a single source for consumers to access information about their home 130. This could include a digital property profile, a single stream for smart device 110 notifications, a home inventory, appliance manuals, repair records, and more.

At one other advantage includes offers and special pricing. Through the connected home ecosystem marketplace, consumers will have access to discounts on individual products as well as offers for bundled pricing on products and services.

Through tools such as HomeScore and partnerships with other businesses, consumers will receive insights and tools to not only help them understand how to improve their home, but the impacts the improvement will have in terms of increasing the health and value of their home 130.

Continued technological advancements in smart home technology and the growing proliferation of connected devices in homes 130 across America represents a massive opportunity for homeowners, insurers, and other interested parties. These advances include:

Reduce Frequency and Severity of Claims. Smart home technology allows us to deliver near-real-time alerts to customers and engage in predictive loss detection to prevent major claim events.

Improved Customer Engagement & Retention. Smart home technology can provide an additional point of contact with customers and provide additional opportunities to engage and strengthen the relationship. In addition, the connected home ecosystem 300 will attract new customers.

Pricing. The vast mine of data generated by smart home devices 110 can be analyzed to engineer incentive-driven pricing and inspire the creation of new products.

New Revenue Streams. The connected home ecosystem allows for generating new revenue streams driven from new products and services, data monetization, B2B relationships, and potentially selling the underlying B2B2C platform and provide differentiated offering in the market vs competitors.

Businesses can gain insights from aggregated data insights generated through the connected home ecosystem. This includes advanced customer behavior insights, home data, and other custom combinations made possible by sophisticated AI/ML models 425 and rich data sources 215, 220, 430, and/or 440.

The connected home ecosystem marketplace 315 offers payment processing, collections, subscription management, and other logistical services to enable a friction-free experience across multiple products and services.

The goal is to operate the ecosystem 300 at the orchestrator level. The home profile may be the “base” of the ecosystem app 415. Business will be vetted that would like to be part of the ecosystem 300 using a defined set of criteria (e.g., brand reputation, financial stability).

The ecosystem 300 is designed to provide valuable and actionable insights to users through the platform 400. While individual solutions will be developed and tested, there may be a design system and style guide developed for the ecosystem 300 that all designers in the residential space will follow when appropriate. This will help with keeping terms and design elements consistent.

The platform 400 will follow enterprise guidelines for availability, stability, and scalability. The platform 400 may be configured to allow for one set of credentials at log in for the ecosystem 300. There may be multiple roles with different definitions in the ecosystem 300 (e.g., orchestrator, supplier, provider).

The platform 400 and ecosystem 300 is configured to present real-time data streams and insights. The platform 400 and ecosystem 300 will support data standardization across multiple data providers and devices.

In some embodiments, the platform 400 and ecosystem 300 may support cases where the data needs to be streamed in real-time. In some cases, near-time and batch approaches may suffice.

The platform 400 and ecosystem 300 will be cloud-based. The platform 400 and ecosystem 300 will support API interaction.

The platform 400 and ecosystem 300 will support KPIs and other metrics to inform performance across all aspects of operations, ranging from customer sentiment/product market fit to technical availability and support response times.

### Exemplary Source Devices

FIG. 8 illustrates exemplary source devices that may be used with the HMA systems 100 and 200 (shown in FIGS. 1 and 2). In the exemplary embodiment, the home controller 135 is in communication with or otherwise monitors or collects data from a variety of source devices within the home network 205. The home 130, and the various source devices therein, may be powered by an electrical distribution system 800. Paths of electrical power flow are illustrated in FIG. 8 in broken lines. The electrical distribution system 800 includes multiple electrical circuits 808, each of which may provide power to one or more of the source devices or other electrical devices 110 within the home 130 (both shown in FIG. 1). Each of the example circuits 808 emanate from an electrical distribution panel 806 that receives power from a power source 810, such as a utility power company or an on-premises power source (e.g., gas generator, solar generator, wind generator). Each circuit 808 may include a circuit breaker for each circuit 808 in the electrical distribution panel 806. While not expressly shown, any of the various source devices 110 may be connected to and powered by the electrical circuits 808.

In the exemplary embodiment, the systems 100 and 200 may include one or more electricity monitoring (“EM”) devices 804. EM devices 804 may be used to monitor electricity flowing to individual electric devices, such as smart devices or appliances, electronics, vehicles, or mobile devices, and may be configured to monitor or detect abnormal usage or trends. Abnormal electricity flow (“EF”) to various devices may indicate that failure is imminent, maintenance or device replacement is needed, de-energization is recommended, or other corrective actions are prudent. For example, the EM devices 804 may be TING® smart sensors such as those made commercially available by Whisker Labs of Germantown, MD.

EF data collected by the EM devices 804 may include data indicative of electricity flow to or from various smart or other electronic devices 110, including the various devices shown here in FIG. 8. EF data may also include electricity or energy usage for each electronic component, device, outlet, circuit, or the like, within the home 130, such as data indicating the electricity each device or room is using. For example, energy usage of air conditioners, washers, dryers, dish washers, refrigerators, stoves, ovens, microwave ovens, televisions, lamps, outlets, computers, laptops, mobile devices, other electronic devices, may be determined by the EM device 804. EF data may be used to detect hazards or other abnormalities that may indicate a risk to the home 130 or its assets.

EM devices 804 may include sensors that are configured to monitor and collect EF data. EM devices 804 may be plugged into electrical outlets within the home (e.g., conventional 110-volt outlets) for at least powering the EM device 804 and/or devices 110 or may be electrically wired into a circuit 808 for powering the EM device 804 and/or devices 110. Further, some EM devices 804 may collect EF data directly from a circuit 808 (e.g., via wired connection to the circuit 808, referred to herein as “direct sensing”) and some EM devices 804 may wirelessly collect EF data from circuits 808, appliances, or other electricity consuming devices (referred to herein as “wireless sensing”). Wireless sensing may include, for example, sensors within the EM device 804 that are configured to sense electromagnetic waves or an electrical signature of the electrical devices receiving power from the electrical distribution system 800. The EM devices 804 may directly or wirelessly detect each flow of electricity to or from each different electronic device by identifying each electronic device by its unique electronic or electrical signature (or “fingerprint”). The EM devices 804 may then generate electricity usage or flow data for each electronic device within the home or connected to the electrical distribution system 800 (such as a hybrid or fully electric vehicle having its battery directly or wirelessly charged by the home's electrical system). In some embodiments, EM devices 804 may be positioned in vicinity of the electrical distribution panel 806 and may capture electrical activity about the home 130 by wirelessly detecting an electricity flow to devices that are coupled to the electrical distribution board 806.

In other embodiments, EM devices 804 may be positioned in vicinity of the electrical distribution panel 806, but not hardwired to the electrical distribution panel 806 or home electrical wiring system, and may capture electrical activity about the home 130 by wirelessly detecting an electricity flow to devices that are coupled to the electrical distribution board 806. In other embodiments, EM devices 804 may be plugged into electrical outlets positioned throughout a home.

During operation, as one or more of the electric devices receives electricity via the electrical distribution system 800, each device may be differentiated by an electrical signature that is unique to a respective device (such as by one or more EM devices 804 monitoring, detecting, and/or analyzing the electricity flowing to or being consumed by each respective electric device, and/or by monitoring EF data generated or collected by one or more EM devices 804).

In other words, transmission of electricity to a refrigerator, for example, may be differentiated from transmission of electricity to an electric stove (such as via one or more EM devices 804 and/or analyzing the EF data generated or collected by one or more EM devices 804). Furthermore, transmission of electricity to a television on one circuit 808 or outlet, for example, may be differentiated from transmission of electricity to another recipient electric device (e.g., a cable television box) via the same circuit 808 or electrical outlet. The systems 100 and 200 may correlate electrical activity with a variety of electric devices on the electrical distribution system 800 based upon electrical signatures unique to each respective device. The systems 100 and 200 may build a structural electrical profile for the home 130, which may include data indicative of operation of the various electric devices within or around the home 130 (e.g., over a period of time), such as by using EF data generated or collected by one or more EM devices 804 over a period of time.

In some embodiments, an EM device 804 may be affixed to or situated near the electrical distribution panel 806. Generally, the EM device 804 may utilize the unique, differentiable electrical signatures of the electric devices by directly or wirelessly monitoring electrical activity including transmission of electricity via the electrical distribution panel 806 to one or more of the electric devices. Monitoring of transmission of electricity to an electric device receiving the electricity may include, for example, monitoring (i) the time at which the electricity was transmitted, (ii) the duration for which the electricity was transmitted, and/or (iii) the magnitude of the electric current in the transmission.

Based upon the unique electrical signatures of the various electric devices of the home 130, the monitored electrical activity may be correlated with respective electric devices receiving the electricity transmitted via the electrical distribution system 800. Further, electrical activity associated with other components of the electrical distribution system 800 (e.g., the electrical distribution panel 806, the circuits 808, or the like) may be correlated with one or more electric devices to which the electrical activity also pertains. In some embodiments, the EM device(s) 804 may perform the correlation or other functions described herein, via one or more processors of the EM device(s) 804 that may execute instructions stored at one or more computer memories of the EM devices 804. In other embodiments, the EM devices 804 may collect the EF data, and the correlation and/or other functions described herein may be performed at another system (e.g., the home controller 135 or the HMA server 150), which may receive data or signals indicative of monitored electricity or other data via one or more processors or through transfer via a physical medium (e.g., a USB drive). Correlation of the electrical activity with the respective electrical devices may produce data indicating, for example, the time, duration, and/or magnitude of electricity consumption by each of the electric devices during a period of electrical activity monitoring.

Based upon at least the correlated electrical activity, a structure electrical profile may be built and stored at the EM devices 804 or at some other system (e.g., the home controller 135 or the home analysis database 235). The structure electrical profile may include, for each of the electric devices about the home 130, data indicative of operation of the respective electric device during at least the period at which the EM devices 804 monitored electrical activity about the home 130. Based upon the correlated electrical activity, the structure electrical profile may depict, for example, average electricity operation/usage, baseline electricity operation/usage, and/or expected electricity operation/usage/consumption. In effect, the structure electrical profile, based upon real electrical activity about the structure, may set forth what is “normal” operation and usage of electricity about the structure.

Thus, once the structure electrical profile is built, any electrical activity monitored via the home controller 135 and the EM device(s) 804 may be analyzed to determine whether electrical activity is abnormal. In response to the abnormal electrical activity, among other possible factors, corrective actions mitigate damage, prevent damage, and/or remedy the cause of the abnormal electrical activity the situation may be determined and/or initiated. Some possible corrective actions are discussed herein.

EF data regarding an electric device may include, for example, historical data indicating the electric device's past operation patterns or trends. For example, historical data may indicate a time of day, day of the week, time of the month, etc., at which an electric device frequently uses electricity (e.g., a lighting fixture may not use electricity during late night hours of the day). As another example, historical data may include the electric device's total electricity consumption or usage rate over a period of time. Additionally or alternatively, historical data may include data indicating past events regarding the electric device (e.g., breakdowns, power losses, arc faults, etc.). Additionally or alternatively, operation data regarding an electric device may include an expected electricity consumption or baseline electricity consumption for the electric device. For example, in the case of a refrigerator, the refrigerator's electricity consumption during a first period of monitoring may be reliably used to approximate an expected electricity consumption at a later time.

Further, the structure electrical profile may include data pertaining to the structure as a whole. For example, the structure electrical profile may include data reflecting a total electricity or average usage rate over a period of time. As another example, the profile may include time-of-day, day-of-week, etc., data reflecting times at which the home 130 as a whole uses more or less electricity. Further, the profile may detail specific types, classes, or specifications of electric devices that behave differently or consume a different amount of electricity compared to other electric devices within the home 130. Further, the profile may detail specific risks determined to be relevant to one or more of the electric devices or to the home 130 as a whole, based upon the electrical activity of the electric devices.

Furthermore, the structure electrical profile may include a digital “map” of the home 130. A home map may indicate spatial locations of the electric devices, and/or spatial relationships between two or more of the electric devices. Such mapping may indicate, for example, a risk associated with the spatial placement of a stove, and/or a risk associated with placing a refrigerator adjacent to the stove. Additionally or alternatively, the home map may indicate which of the electric devices are connected to each electrical circuit 808 within the electrical distribution system 800 of the home 130. Such mapping may indicate, for example, a risk of overloading a particular circuit 808 based upon a number or intensity of electric devices connected to the circuit 808. As another example, the home map may be used to determine what electric devices may lose power if a particular circuit 808 were to be de-energized (e.g., due to risk or abnormal electrical activity associated with one electric device on the circuit).

In some embodiments, the home map may be configurable by a user (e.g., the homeowner of the home 130). The user may, for example, configure the map via an I/O module (e.g., screen, keypad, mouse, voice control, etc.) of the home controller 135, or via an I/O module of another computing device, which may transmit the home map to the home controller 135. Additionally or alternatively, the home map may be stored at one or more computer memories of another system (e.g., HMA server 150).

In some embodiments, the home network 205 may include a home power management system 826. The home power management system 826, or the controller 135 in conjunction with the EM devices 804, may collect power consumption data on the circuits 808 (e.g., via EM devices 804) or device electrical usage data of various electronic devices within the home 130. The home power management system 826 may, for example, collect usage data for lights or appliances within the home 130, giving an indication of how much electricity the home 130 uses or how frequently occupants are at home. In some embodiments, the home 130 may include one or more smart plugs (not separately shown) which may be managed by the power management system 826, the smart speaker device 818, the smart home system 824, or otherwise by the systems 100 and 200 (e.g., for activating or deactivating devices plugged into the circuits 808 via the smart plugs, such as via 110-volt outlets).

The home power management system 826 may identify and provide details on what appliances or other consuming devices are within the home 130 (e.g., manufacturer make and model), thereby allowing the systems 100 and 200 to identify some property on the premises (e.g., device identification and verification, device count), evaluate value of devices (e.g., replacement costs), or collect manufacturer-provided or consumer protection-provided details regarding the devices from external data sources 215 (e.g., susceptibility of the device to power surges, likelihood of fire caused by the device, mean time to failure of the device, types of device failures, power consumption profiles and tolerances of the device, or the like).

The home power management system 826 may collect power quality data for the home 130, such as occurrences and frequency of power outages or reductions in service (e.g., black-outs or brown-outs), loading at various times throughout the day or week, the size of service, occurrences of voltage values fluctuating beyond tolerance ranges (e.g., spikes), or the like. In some embodiments, the home power management system 826 may include one or more smart circuit breakers (e.g., on any or all of the circuits 808) or a smart panel (e.g., as the electrical distribution panel 806), such as those made commercially available by Schneider Electric (Paris, France), which may provide circuit-level data and operations such as, for example, current or historical circuit load data, circuit breaker status, or turning circuit breakers on or off. Such power data may be used to construct a power profile for the home 130. In some embodiments, the home controller 135 may perform any such power monitoring and data collection operations in lieu of, or in addition to, the home power management system 826.

In the exemplary embodiment, the home 130 may include one or more smart appliances 812 (e.g., appliances that can communicate via the home network 205, which may include devices 110). Smart appliances 812 may include, for example, dish washers, microwaves, stove tops, ovens, grills, clothes washers and dryers, water heater, water meter, water softener or purifier, smart lighting, smart window blinds or shutters, piping, interior or yard sprinklers, or the like. The home controller 135 may be configured to communicate with such smart appliances 812 and may collect home data from such appliances for the systems 100 and 200.

For example, the appliances 812 may provide data such as device data (e.g., manufacturer, make, model, date of manufacturer, date of installation, software or firmware versions), usage data (e.g., daily usage time, power consumption), or log data (e.g., log events, alerts, component failure detections, maintenance history, or the like). Such appliance data may allow the systems 100 and 200 to detect which appliances are present in the home 130 (broadly, as a part of an “asset inventory” of the house), their replacement value, age of each appliance, a maintenance history of each appliance, to detect when appliances or their components are failing.

The system 800 may use such data, for example, to construct the power profile for the home 130, to compute the safety score for the home 130, to compute in an insurance profile for the home (e.g., as factors of risk to lightning or other hazards), or to alert the homeowners when an appliance registers a failure.

In the exemplary embodiment, the home 130 may also include smart HVAC devices such as, for example, a heater (e.g., a gas or electric furnace), an air conditioner, an air purifier, an attic fan, a ceiling fan. Some or all such devices may be controlled by a thermostat device. Such devices are collectively referred to herein as HVAC devices 814, some of which may not be smart devices but may nonetheless be controlled in some respects by the thermostat device.

The systems 100 and 200 may collect HVAC data such as device data (e.g., manufacturer, make, model, date of manufacturer, date of installation), usage data (e.g., daily usage time, power consumption), or thermostat data (e.g., temperature settings, daily schedule profiles). The systems 100 and 200 may use such data, for example, to construct the power profile for the home 130, to compute the safety score for the home 130 (e.g., determining how often the home 130 is typically occupied), to compute in an insurance profile for the home (e.g., as factors of risk to lightning or other hazards, likelihood of equipment failures), or to alert the homeowners when an HVAC device registers a failure.

The home 130, in the exemplary embodiment, may also include various computing devices such as, for example, desktop or laptop personal computers, tablet computers, servers, or networking devices (e.g., Wi-Fi routers, switches, hubs, firewalls, or the like), all of which are collectively represented here as home network/computer devices (or just “computer devices”) 816. The networking devices may provide some or all of the home network 205 that is used to facilitate communication between the devices shown here. The home controller 135 may be configured to capture computer device data from some or all of these computer devices 816 such as, for example, a number and type of computing devices (e.g., hardware manufacturer, make, model, and the like), hardware and software profile of computing devices, configuration data of computing devices (e.g., software versions, firmware versions), usage data, and log data (e.g., firewall logs, access logs, software patch logs, error logs). The systems 100 and 200 may use such data to, for example, determine asset inventory and valuation, construct the power profile for the home 130 (e.g., average daily usage), alert the homeowners when devices need software or firmware upgrades (e.g., critical security alerts) or upon intrusion detection or other compromise of computer devices 816 (e.g., software hacks).

In the exemplary embodiment, the home 130 may include a smart speaker device(s) (or “nest device”) 818 that may interact with occupants of the home 130 (e.g., via audible commands and responses, digital display, executing pre-configured actions). Some example smart speaker devices 818 include the Echo® devices (Amazon Inc., of Seattle, Washington) and the Google Nest® devices (Alphabet Inc., of Mountain View, California), to name but a few. The smart speaker device 818 may include a speaker for providing audio output, a microphone for receiving audio input (e.g., commands spoken by the occupants), and may include a display device for video output or a camera device for capturing video input. The smart speaker device 818 may be configured to interact with other smart devices, such as for controlling lighting within the home 130, the thermostat (e.g., changing thermostat settings), home security devices of a home security system 820 (e.g., locking and unlocking smart locks on doors, opening or closing garage doors, or the like), or entertainment devices of a home entertainment system 826 (e.g., enabling, disabling, or reconfiguring music or television devices).

The systems 100 and 200 may, with owner configuration and permission, utilize inputs from the smart speaker device 818 to, for example, determine a number of unique occupants of the home 130 (e.g., via unique speech profile or video identification), determine the number of children in the home 130 (e.g., via audio or video analysis), determine when occupants of the home 130 are currently or historically present (e.g., via noise detection, video movement), determine when other devices are turned on or off, determine presence of pets (e.g., via unique audio sounds or video identification of the pets), or smoke or carbon monoxide alarm detection (e.g., via audible sound). Such raw data may be sanitized or distilled by the home controller 135 into refined data before sending to the HMA server 150 in an effort to protect privacy of the home occupants while still providing home health evaluation and risk capabilities (e.g., sending results determined from the raw audio or video data and deleting the raw audio or video data). The systems 100 and 200 may anonymize personal data, thereby allowing data to be stored or used without direct attribution of data to a particular homeowner.

In the exemplary embodiment, the home 130 may include various home entertainment devices 820 such as, for example, televisions, digital video recorders (“DVR”), radios, amplifiers, speakers, remotes, or console gaming systems, any or all of which may be smart devices in communication with the home network 205 and the controller 135. The controller 135 may collect home entertainment data from such devices and may use that data, for example, to construct the power profile for the home 130, to construct the asset inventory of the home 130, to compute the safety score for the home 130, to compute in an insurance profile for the home (e.g., as factors of risk to lightning or other hazards, likelihood of equipment failures).

The home 130, in the exemplary embodiment, may include a home security system 822. The home security system 822 may include security devices such as, for example, door or window sensors (e.g., to detect when doors or windows or open, when windows are broken), motion sensors (e.g., to detect when someone is present within range of the sensor), security cameras (e.g., for capturing audio/video of particular areas in or around the house 130, such as a doorbell camera), key pads (e.g., for enabling/disabling the security system), panic buttons (e.g., for alerting a security service or authorities of an emergency situation), security hubs (e.g., for integrating individual security devices into a security system, for centrally controlling such devices, for interacting with third parties), electric door locks, or smoke/fire/carbon monoxide detectors. Such “security devices” broadly represent devices that can detect potential contemporaneous risks to the home 130 or its occupants (e.g., intrusion, fire, health). The home security system 822 may be configured to communicate with a third-party security service or local authorities, and may transmit alerts to such parties when events are detected. The home controller 135 may be configured to receive alert data from the home security system 822 and may transmit such alerts to the HMA server 150, create historical logs of security events, or transmit alert events directly to the homeowner (e.g., via SMS text message or the like) or to local authorities, fire protection, or emergency services. The systems 100 and 200 may use such security alert events to, for example, determine how frequently security events occur (e.g., as a factor for risk), how often such events are warranted (e.g., authentic risks rather than false alarms), or the type and nature of such authentic risks or false alarms.

The systems 100 and 200 may use raw data collected directly from any of these security devices. For example, the home controller 135 may use raw data from the motion sensors to detect when the home 130 is occupied (e.g., to build a profile of occupancy times), may use raw data from the camera devices or door devices to detect when occupants enter or exit the home 130, may use the camera devices to determine a number of occupants of the home 130 or a number and type of pets in the home 130. The home controller 135 may determine information about the home security system 822 installed within the home, such as a number and type of security sensors installed within the home 130, a type of home security system 822 installed in the home (e.g., third-party service provider, device manufacturers, types of security protection implemented within the home), or how often the homeowners leave the house 130 unoccupied without activating the home security system 822 (e.g., as a factor in risk calculations or home health scoring). The systems 100 and 200 may rate the home security system 822 and associated devices and services to generate a home security protection rating (e.g., relative to other available security systems or hardware) and may use that rating as a factor in risk calculations or in preparing a risk mitigation proposal (e.g., for more or better devices or security systems).

In some embodiments, the home 130 may include a smart home system 824 (e.g., a home monitoring system) that allows the homeowner and occupants to control various devices within the home 130. For example, the smart home system 824 may be configured to control, inter alia, devices such as the smart appliances 812, HVAC devices 814, home entertainment devices 820, or home security system 822. In the exemplary embodiment, the home controller 135 may be configured to interact directly with such devices as described herein (“direct access”) or may be configured to perform some interactions and data collections with such devices through the smart home system 824 (“proxy access”). For example, any or all of the data collections or operations described herein may be performed by the smart home system 824 based upon commands received from the home controller 135, thereby allowing the systems 100 and 200 to perform such operations through the smart home system 824 acting as a proxy for some such operations.

In the exemplary embodiment, the home 130 may include a home car charging station 828 that may be used to recharge electric vehicles 140 (shown in FIG. 1). The home car charging station 828 may draw power from one or more of the circuits 808 of the electrical distribution system 800 and may include an on-premises power source (e.g., solar panels, wind generator, or the like) or a dedicated battery bank (e.g., for storing excess power from the local energy source). The systems 100 and 200 may capture various charging station data from the home car charging station 828, from the circuits 808 used for the charging station 828, or from the local power source device(s).

For example, the controller 135 may collect device information from the devices (e.g., manufacturer, make, model), vehicle information (e.g., via wireless connection with the vehicle to collect manufacturer, make, model, year of manufacture, options, software versions, usage, miles driven, battery health information, vehicle health information), or power information (e.g., recharging statistics, power used, power generated, recharging history). Such information may be used, for example, to build the power profile, to determine when the vehicle(s) 140 are on the premises, to determine asset inventory, or to determine power inefficiencies related to recharging (e.g., cost analysis of utility power use versus local power generation and storage relative to when the vehicle(s) are on the premises). The information may also be used to build profiles of the vehicles 140 to be able to compare to determine if issues arise.

In the exemplary embodiment, the home 130 may include one or more smart alarms 830 that are configured to detect various conditions within the home 130 and may alert the homeowner or other occupants (e.g., via audible alarm, SMS text message, email, or the like). Smart alarms 830 may include, for example, smoke detectors, carbon monoxide detectors, carbon dioxide detectors, or indoor air quality (“IAQ”) monitors or systems that include sensors configured to, for example, detect dangerous conditions such as fire or buildup of carbon monoxide, the presence of dangerous pollutants such as radon or various volatile organic compounds (“VOC”), or collect various air quality data such as temperature and humidity. Smart alarms 830 may include water leak detectors or flood alarms that may be configured to detect the presence of water at various areas in the home 130, such as near HVAC equipment, water tanks, sump pumps, below showers or bathtubs, around basement perimeters, behind or within basement walls, or the like. Such water detectors may identify leaks within plumbing or appliances within the home 130 or ingress of water into the home 130 (e.g., rainwater, flooding, failing sump pump, foundation cracks, or the like). The home health system 100 may collect alarm data from the smart alarms 830 and may perform automatic alerting based upon sensor events registered at such smart alarms 830 (e.g., alerting emergency services, homeowner, or the like, in an effort to protect life and property, mitigate damage, or such) or initiate automatic actions (e.g., shutting off water flow within the home 130, or within a particular segment of plumbing, via activating a smart water shut off valve, not separately shown). The systems 100 and 200 may identify the presence of such smart alarms 830 or shut off valves in the home 130 when configured to communicate with the smart alarms 830 and may automatically provide policy discounts when particular smart alarms 830 are detected as present or may include the presence or absence of such smart alarms 830 in the various aspects of home health scoring. Furthermore, the HMA server 150 may be configured to provide marketplace suggestions of providers to assist with the issues that are associated with the alarms.

### Exemplary External Data Sources

In the exemplary embodiment, and referring now to FIG. 2, the system 200 may collect various types of external data from external data sources 215 that may be used, for example, for home health evaluation, for risk scoring, for generating home health remediation recommendations, or other various uses described herein. Some external data sources 215 may provide publicly available data, where other external data sources 215 may be private, third-party sources. External data sources 215 may include an insurance provider that provides insurance policies to the homeowner and various data available or otherwise collected by that insurance provider. In some embodiments, the HMA server 150 may be operated by the insurance provider and the home health database may include data private to the insurance provider (e.g., customer data, policy information, or other proprietary information).

In the exemplary embodiment, one example external data source 215 is the NOAA or any of its various branches (e.g., the national weather service). The NOAA makes various weather data publicly available. As such, the system 200 may collect weather data from the NOAA. Such weather data may be refined to a particular geography, such as a state, county, city, or other geographic region. The system 200 may, for example, identify a geographic region of the home 130 and submit data queries to the NOAA for weather data specific to that geographic region. Such data queries may include requests for historical data such as average rainfall, storm occurrences, wind strengths, lightning strikes, temperatures, tornado events, or the like. Historical data may be used to, for example, evaluate future risks to the home 130 over time. Data queries may include requests for forecast data such as severe watches warnings, tornado watches or warnings, flooding watches or warnings, precipitation predictions, wind predictions, lightning event predictions, blizzard warnings, or the like. Forecast data may be used to, for example, generate and send weather alerts to the homeowner or occupants of the home 130 or determine how frequently the home 130 experiences various warnings or alerts over time.

In the exemplary embodiment, another example external data source 215 may be the U.S. Forest Service. The U.S. Forest Service maintains historical data related to forest fires and tracks active forest fires in the United States. As such, the home health system 100 may collect forest fire data from the U.S. Forest Service. Such forest fire data may similarly be refined to a particular geography, such as a state, county, city, or other geographic region. The system 200 may, for example, collect historical forest fire data for the geographic region of the home 130, or may collect current forest fire data at or near the location of the home 130 (e.g., within a pre-defined distance from the home, within a distance from a projected path of the forest fire). The system 200 may use historical forest fire data to, for example, evaluate future risk of forest fires to the home 130. The home health system 200 may use current forest fire data to, for example, generate and send forest fire alerts to the homeowner or occupants of the home 130, or as factors in home health scoring.

In the exemplary embodiment, another example external data source 215 may be municipal power utilities. The system 800 may access current or historical power network data provided by power utility companies in various localities, such as power generation performance statistics (e.g., generation and load statistics), power transmission and distribution statistics or power outage information (e.g., across the network, local to a distribution segment that services the home 130, consistencies of voltages, power sags, power surges, brown-outs or black-outs and associated frequencies or lengths of outages, or the like), lightning strike data affecting the power network, or electrical consumption data for the home 130 (e.g., current or historical power usage, local power generation provided back to the network). The home health system 100 may use current power network data to, for example, generate and send alerts to the homeowner during power outages (e.g., as SMS text messages or emails that can be viewed on mobile computing devices), or as factors in home health scoring.

In the exemplary embodiment, another example external data source 215 may be third-party home data systems such as Multiple Listings Service (“MLS”), Zillow (www.zillow.com), or other Internet-accessible sources for property data. The system 200 may access such home data systems to collect construction details about the home 130 such as, for example, the age of the home, how many bedrooms and bathrooms the home 130 has, the type of any HVAC, the square footage of the home 130, the size of the property, market price of the home, whether the home 130 is constructed of wood, brick, concrete, or the like, the type and size of any garage, the quality of materials used to construct the home 130, whether the home 130 has a basement, the type, age, or condition of plumbing or wiring inside and outside the home 130, whether the home 130 has a pool and safety fence around the pool, the type of roofing, the floor plan, the architecture of the home 130 (e.g., ranch, two story, split foyer), the type of flooring, the type of exterior (e.g., wood, brick, siding), type of local power generation on the property (e.g., solar, wind, generator), number of fire places, type of fencing or gutters, whether the home 130 has a pool, sheds, patios, porches, or other exterior structures, whether the home 130 has outside doors having steps, type of ducting and insulation within the home 130, type of landscaping around the home 130, or mobility or accessibility options within the home 130.

Some home statistics data may include geographic data about the home 130 such as, for example, school district information (e.g., public school system, school ratings), utility providers available to at the location (e.g., electric, gas, sewer, waste, recycling, phone, Internet, television, fire, police, hospital, or other city services), proximity data to various services and amenities (e.g., distances from schools, parks, grocery, gas, library, or sources of entertainment), hazard data for the area (e.g., crime statistics, natural disaster statistics, ratings for emergency services), Some home statistics data may include historical data, such as price history (e.g., sales history, listings history), public tax history, insurance claims history, home warranty information, home inspection information, lease information (e.g., whether and how often the home 130 has been partially or fully rented or leased), or the like. Some home statistics data may include home energy data such as, for example, whether the home 130 is energy certified, type and size of power generation, home appliance or lighting energy certification data, or the like.

In the exemplary embodiment, another example external data source 215 may be an insurance provider or other service provider that has an economic or consumer relationship with the homeowner. The system 200 may access the service provider systems to collect demographic details about the home 130 and its occupants, such as, for example, names or ages of the occupants, education levels or occupations of the occupants, whether any of the occupants smoke, a family emergency plan, community engagement of the occupants, or whether a business is operated out of the home 130. The service provider system may collect home maintenance data about the home 130 such as, for example, maintenance logs of operations performed on the home 130 (e.g., service calls, property damage and fixes, routine device maintenance, cleanings, bug or pest service, lawn or garden service, roofing replacement, or the like), equipment installations and removals, device warranty information, or home improvements (e.g., new deck, pool, room(s), interior or exterior painting or weather proofing, solar installation, water reclamation systems installation, room remodeling, or the like). The service provider system may collect home configuration data about the home 130 such as, for example, whether GFCI outlets or LED lights are installed in the home 130, whether power strips supporting multiple devices are in use, whether the home 130 has exercise equipment, types of grills or fryers installed in the home 130, whether the home 13 includes particular safety equipment (e.g., smoke or carbon monoxide detectors, fire extinguishers, deadbolts on exterior doors, water sensors, sump pump, or the like), paint colors used on various walls of the home 130.

In some embodiments, the service provider may be the operator of the HMA server 150 and the homeowner may provide such data via an input interface (e.g., online questionnaire, user interface, service application, or the like, during participation in the home health system described herein). Collection and use of such data may be opted into by the homeowner on behalf of the occupants. In some embodiments, the system 200 may query the homeowner for any data elements described herein and not otherwise automatically accessed by the system 200.

In the exemplary embodiment, the system 200 may access aerial data of the home 130, such as satellite-, aerial-, or drone-captured overhead images of the home 130 and surrounding property. Such aerial data may be used to determine various externally visible features of home data (e.g., via digital image processing, machine learning, or human analysis). For example, the home health system 200 may use aerial data to determine structural elements of the home 130 or surrounding property, such as whether the home 130 has a swimming pool, a fence, or a deck, how many garages the home 130 has, or the like. The system 200 may use aerial data to determine whether the home 130 has trees nearby (e.g., which may cause damage to the home 130) or whether the home 130 is located on a cul-de-sac or a busy road. Such aerial data may be provided by a third party or public external data source 215 (e.g., United States Geological Survey (“USGS”), National Aeronautics and Space Administration (“NASA”), NOAA, Google®, or the like) or may be privately collected (e.g., via aerial or drone photography of the home 130 by the insurance provider, realtor, or the like). Such aerial data may include global positioning system (“GPS”) location data for the home 130.

The system 200 may train a model of satellite images of homes 130 with labeled data of the homes 130 indicating, for example, whether the homes 130 have pools, decks, nearby trees, or other such features. As such, the trained model may be configured to automatically evaluate an unlabeled home (e.g., the home 130 in FIG. 1) to determine whether such features are present or otherwise categorize the home 130 with respect to those features.

In some embodiments, the system 200 may access mapping data around the home 130 to determine various home health features. The system 200 may utilize a web mapping service (e.g., Google® Maps or the like) as an external data source 215. For example, the system 200 may access the web mapping service via an application programming interface (“API”) that allows the home health system 200 to submit, for example, the postal address of the home 130 or a GPS coordinate of the home 130 and query the web mapping service to provide features such as distances to nearby services (e.g., distance to nearest hospital, fire department, police station, schools, places of worship, parks, grocery stores, to various types of entertainment or other amenities, or the like). Mapping data may be used to determine whether the home 130 is situated on a busy or isolated road. The system 200 may generate a play score for the home 130 using the mapping data, where the play score evaluates proximity of the home 130 to various types of entertainment or exercise venues, such as proximity to hiking trails, bike paths, sports fields, professional sports venues, restaurants, theaters, or the like).

The mapping data may include ground-level imagery provided by the web mapping service that may be used by the system 200 to evaluate various externally visible features of home data (e.g., via digital image processing, machine learning, or human analysis). For example, the system 200 may use ground-level imagery to determine structural features of the home 130 such as a number of stories of the home, type of windows installed in the home, a roof type or type of exterior of the home, or how many garages the home has. The system 200 may train a model of ground-level images of homes 130 with labeled data of the homes 130 indicating, for example, how many stories or garages the homes 130 have, what type of exterior or roof type the homes 130 have, or other such features. As such, the trained model may be configured to automatically evaluate an unlabeled home (e.g., the home 130 in FIG. 1) to determine whether such features are present or otherwise categorize the home 130 with respect to those features.

### Exemplary Computer System

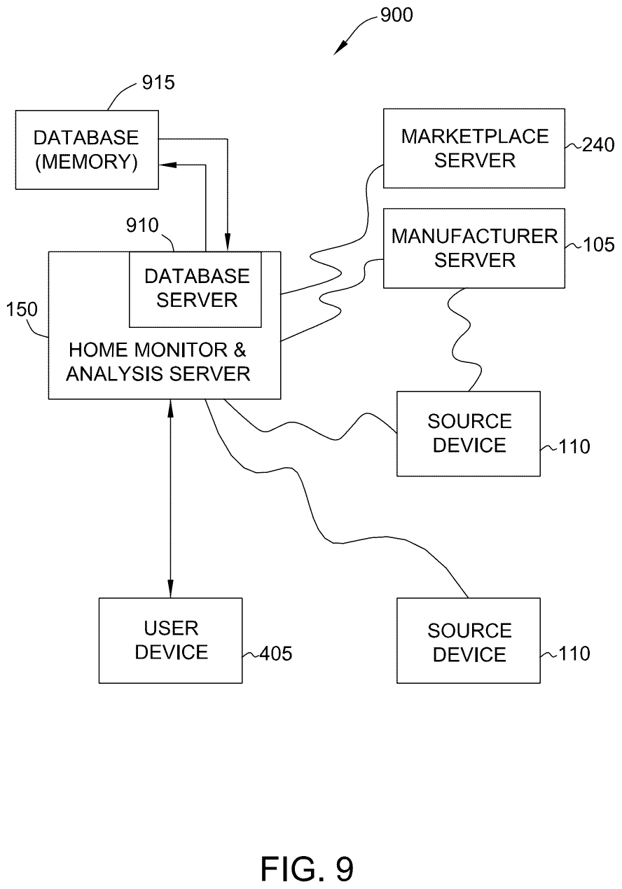

FIG. 9 illustrates an exemplary computer system 900 for implementing the home monitoring and analysis (HMA) systems 100 and 200 (shown in FIGS. 1 and 2) performing the process 500 (shown in FIG. 5). In the example embodiment, the system 900 is used for analyzing sensor data and external data associated with a home 130 (shown in FIG. 1) to detect issues with that home and to propose actions to mitigate those issues.

As described below in more detail, the HMA server 150 is programmed to analyze sensor data and external data associated with a home to detect issues with that home and to propose actions to mitigate those issues. The HMA server 150 is programmed to (1) receive a first element of home data from the home controller 135 (shown in FIG. 1); (2) determine a safety score for the residential property 130 based at least in part on the first element of home data, the safety score representing a measure of safety of the residential property 130; (3) receive a first element of external data from the one or more external data sources 215 (shown in FIG. 1), the first element of external data relating to a geographical region of the residential property; (4) determine a home health score for the residential property based at least in part on one or more of the first element of home data provided by the one or more smart devices 110 and the first element of external data from the one or more external data sources 215, the home health score representing a measure of health of the residential property 130; (5) determine at least one product provider 245 and service provider 250 to be able to improve the home health score based at least in part upon the first element of home data and the first element of external data; and/or (6) cause to be displayed, to a homeowner of the residential property 130 via a graphical user interface, information about the at least one product provider 245 and service provider 250 to improve the home health score.

In the example embodiment, user devices 405 are computers that include a web browser or a software application, which enables user devices 405 to communicate with HMA server 150 using the Internet, a local area network (LAN), or a wide area network (WAN). In some embodiments, the client devices 405 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 405 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, smart contact lenses, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, source devices 110 are computers that include a web browser or a software application, which enables source devices 110 to communicate with HMA server 150 using the Internet, a local area network (LAN), or a wide area network (WAN). In some embodiments, the source devices 110 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Source devices 110 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, smart contacts, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. In the exemplary embodiment, source devices 110 are devices connected to the home network 205 (shown in FIG. 2) that provide information about the home 130.

In the example embodiment, manufacturer servers 105 are computers that include a web browser or a software application, which enables manufacturer servers 105 to communicate with associated source devices 110 and the HMA server 150 using the Internet, a local area network (LAN), or a wide area network (WAN). In some embodiments, the manufacturer servers 105 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The manufacturer servers 105 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, smart contacts, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, marketplace servers 240 are computers that include a web browser or a software application, which enables marketplace servers 240 to communicate with associated the HMA server 150 using the Internet, a local area network (LAN), or a wide area network (WAN). In some embodiments, the marketplace servers 240 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The marketplace servers 240 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, smart contacts, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, the HMA server 150 (also known as HMA computer device 150) is a computer that includes a web browser or a software application, which enables HMA server 150 to communicate with user devices 405 using the Internet, a local area network (LAN), or a wide area network (WAN). In some embodiments, the HMA server 150 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The HMA server 150 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, smart contacts, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. In some embodiments, HMA server 150 is similar to or a part of connected home ecosystem server 410 (shown in FIG. 4).

A database server 910 is communicatively coupled to a database 915 that stores data. In one embodiment, the database 915 is a database that includes home data, sensor data, property data, and/or mitigation actions. In some embodiments, the database 915 is stored remotely from the HMA server 150. In some embodiments, the database 915 is decentralized. In the example embodiment, a person can access the database 915 via the user devices 405 by logging onto HMA server 150. In some embodiments, database 915 may include home analysis database 235, external databases 220 (both shown in FIG. 2), home ecosystem database 430, and/or third-party database 440 (both shown in FIG. 4).

### Exemplary Client Device

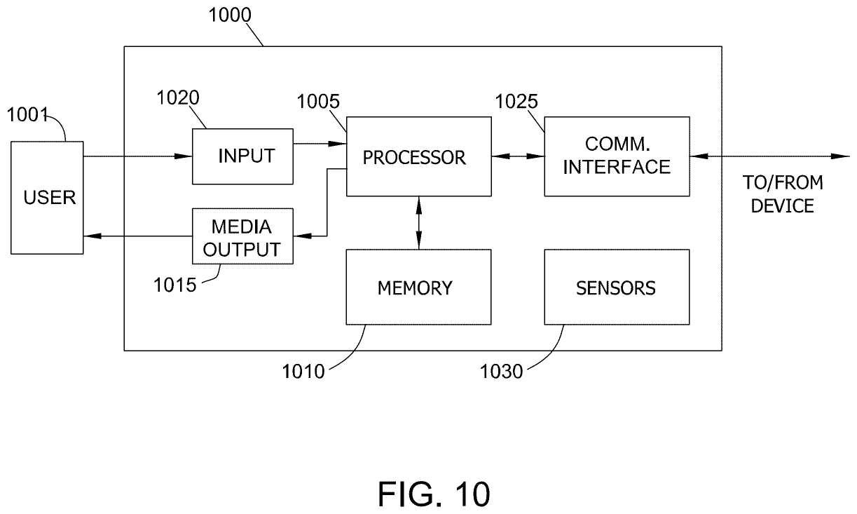

FIG. 10 depicts an exemplary configuration of a client computer device shown in FIGS. 1, 2, 4 and 9, in accordance with one embodiment of the present disclosure. User computer device 1002 may be operated by a user 1001. User computer device 1002 may include, but is not limited to, devices 110, IoT camera 115, IoT thermostat 120, IoT door lock 125, vehicle controller 145 (all shown in FIG. 1), user device 405 (shown in FIG. 4), EM devices 804, HVAC devices 814, home network computer devices 816, smart speaker devices 818, home entertainment devices 820, home security system 822, smart home system 824, home power management system 826, and home charging station 828 (all shown in FIG. 8). User computer device 1002 may include a processor 1005 for executing instructions. In some embodiments, executable instructions are stored in a memory area 1010. Processor 1005 may include one or more processing units (e.g., in a multi-core configuration). Memory area 1010 may be any device allowing information such as executable instructions and/or transaction data to be stored and retrieved. Memory area 1010 may include one or more computer readable media.

User computer device 1002 may also include at least one media output component 1015 for presenting information to user 1001. Media output component 1015 may be any component capable of conveying information to user 1001. In some embodiments, media output component 1015 may include an output adapter (not shown) such as a video adapter and/or an audio adapter. An output adapter may be operatively coupled to processor 1005 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (extended Reality) headsets), and/or voice or chat bots.

In some embodiments, media output component 1015 may be configured to present a graphical user interface (e.g., a web browser and/or a client application) to user 1001. A graphical user interface may include, for example, an online score viewing interface for viewing a home health score and determining more information about the home health score. In some embodiments, user computer device 1002 may include an input device 1020 for receiving input from user 1001. User 1001 may use input device 1020 to, without limitation, select a provider.

Input device 1020 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 1015 and input device 1020.

User computer device 1002 may also include a communication interface 1025, communicatively coupled to a remote device such as the HMA server 150 (shown in FIG. 1), the marketplace server 240 (shown in FIG. 2), and/or the connected home ecosystem server 410 (shown in FIG. 4). Communication interface 1025 may include, for example, a wired or wireless network adapter and/or a wireless data transceiver for use with a mobile telecommunications network.

Stored in memory area 1010 are, for example, computer readable instructions for providing a user interface to user 1001 via media output component 1015 and, optionally, receiving and processing input from input device 1020. A user interface may include, among other possibilities, a web browser and/or a client application. Web browsers enable users, such as user 1001, to display and interact with media and other information typically embedded on a web page or a website from the HMA server 150, the marketplace server 240, and/or the connected home ecosystem server 410. A client application allows user 1001 to interact with, for example, the HMA server 150, the marketplace server 240, and/or the connected home ecosystem server 410. For example, instructions may be stored by a cloud service, and the output of the execution of the instructions sent to the media output component 1015.

Processor 1005 executes computer-executable instructions for implementing aspects of the disclosure. In some embodiments, the processor 1005 is transformed into a special purpose microprocessor by executing computer-executable instructions or by otherwise being programmed.

### Exemplary Server Device

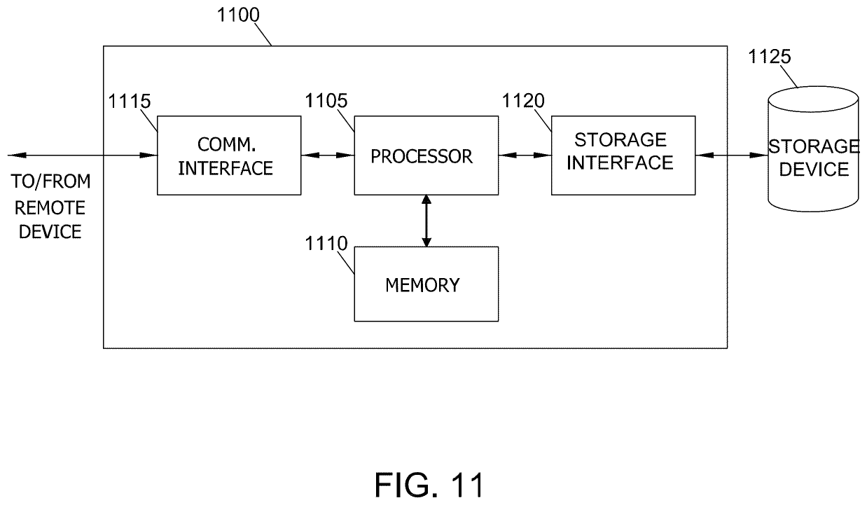

FIG. 11 depicts an exemplary configuration of a server 150 shown in FIG. 1, in accordance with one embodiment of the present disclosure. Server computer device 1100 may include, but is not limited to, manufacturer server 105, home controller 135, HMA server 150 (both shown in FIG. 1), external data sources 215, marketplace server 240 (both shown in FIG. 2), home security system 822, smart home system 824, home power management system 826, (all shown in FIG. 8), connected home ecosystem server 410, third-party servers 435 (both shown in FIG. 4), and database server 910 (shown in FIG. 9). Server computer device 1100 may also include a processor 1105 for executing instructions. Instructions may be stored in a memory area 1110. Processor 1105 may include one or more processing units (e.g., in a multi-core configuration).

Processor 1105 may be operatively coupled to a communication interface 1115 such that server computer device 1100 is capable of communicating with a remote device such as another server computer device 1100, marketplace server 240, connected home ecosystem server 410, or user devices 405 (shown in FIG. 4). For example, communication interface 1115 may receive requests from client devices 405 via the Internet, as illustrated in FIG. 9.

Processor 1105 may also be operatively coupled to a storage device 1134. Storage device 1134 may be any computer-operated hardware suitable for storing and/or retrieving data, such as, but not limited to, data associated with database 915 (shown in FIG. 9). In some embodiments, storage device 1134 may be integrated in server computer device 1101. For example, server computer device 1100 may include one or more hard disk drives as storage device 1134.

In other embodiments, storage device 1134 may be external to server computer device 1100 and may be accessed by a plurality of server computer devices 1100. For example, storage device 1134 may include a storage area network (SAN), a network attached storage (NAS) system, and/or multiple storage units such as hard disks and/or solid-state disks in a redundant array of inexpensive disks (RAID) configuration.

In some embodiments, processor 1105 may be operatively coupled to storage device 1134 via a storage interface 1120. Storage interface 1120 may be any component capable of providing processor 1105 with access to storage device 1134. Storage interface 1120 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1105 with access to storage device 1134.

Processor 1105 may execute computer-executable instructions for implementing aspects of the disclosure. In some embodiments, the processor 1105 may be transformed into a special purpose microprocessor by executing computer-executable instructions or by otherwise being programmed. For example, the processor 1105 may be programmed with the instructions such as illustrated in FIG. 5.

### Exemplary User Interface

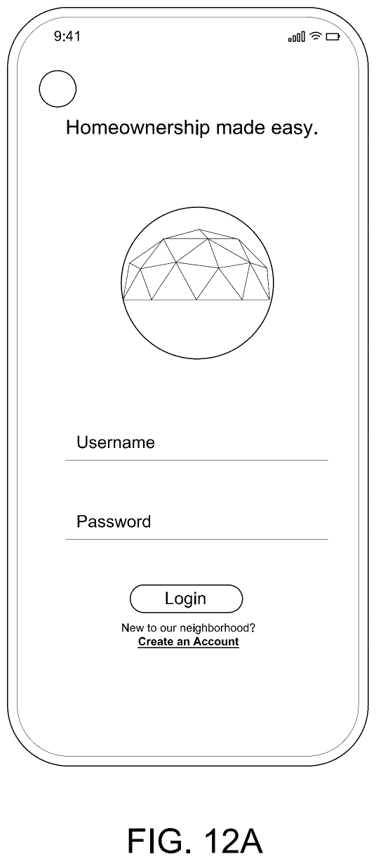

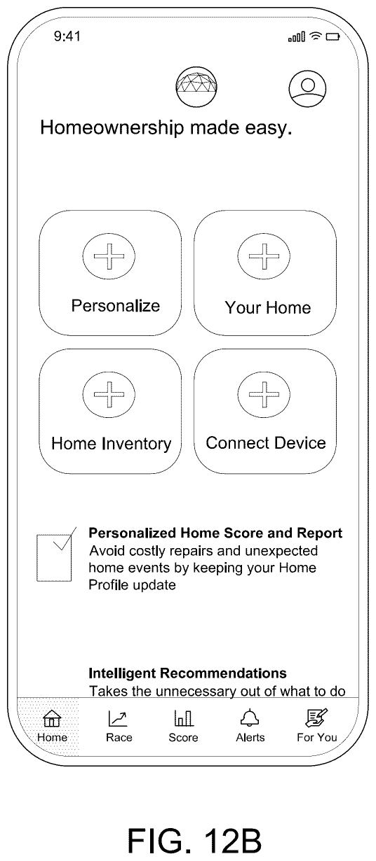

FIG. 12A illustrates an exemplary user interface displaying a login page for a connected home ecosystem application. The connected home ecosystem application may be derived from a full-featured, data-based view of a property using home data, third party property characteristics data and machine learning based models. The connected home ecosystem application may perform calculations that uses a proprietary mix of characteristics to provide a holistic view regarding the well-being of a home. Elements about the home, as well as the surrounding environment, may be taken into consideration as part of the calculation.

The connected home ecosystem application may include a connected home ecosystem dashboard that calculates subcategories of safety and structural risks for a home based on home and external data. A connected home ecosystem application may allow a user to search for their home address and see a dynamic “Home Profile Dashboard” that includes a personalized Home Score, recommendations, and marketplace. The user may then drill down on specific elements and details through the dashboard.

The connected home ecosystem application may provide an immersive customer experience through a personalized user interface built from existing, user-validated inputs. These inputs may include are not limited to, personalized report and score, intelligent recommendations, calendar sync, profile builder, home details, home inventory, and connected devices. The personalized report and score may be generated from user-inputs as shown herein, or other user-inputs. Intelligent recommendations may be powered by artificial intelligence (AI). The calendar sync may allow users to record important maintenance repair and replacement dates and appointments. The profile builder may allow the user to verify contact information and set preferences. Home details may include home data and set preferences. Home inventory may include stored photos of rooms, valuables, and assets.

Connect devices may be or include different services and devices that may be provided by other companies. Examples include, security monitoring, dampness monitoring, electrical system monitoring, and/or other systems or services.

FIG. 12B illustrates an exemplary user interface displaying a screenshot of a profile builder page for the connected home ecosystem application. The profile builder may allow the user to setup and personalize their account. The profile builder may allow the user to set-up based upon different categories including, personalize, Your Home, home inventory, and connect devices.

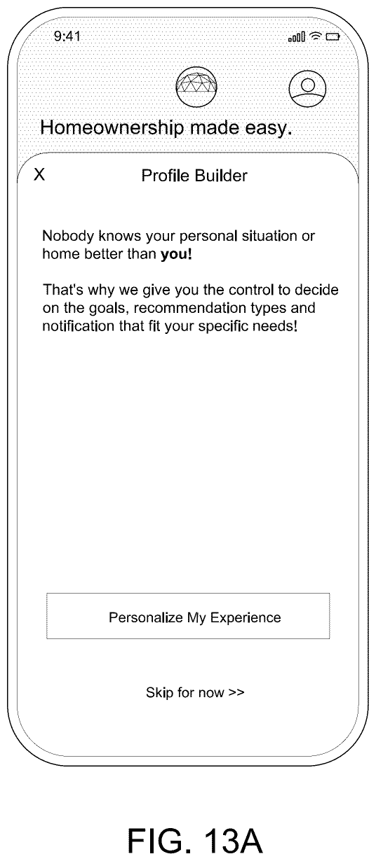

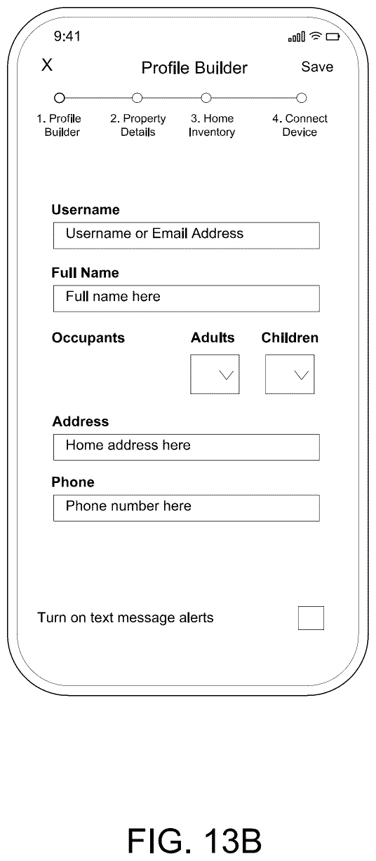

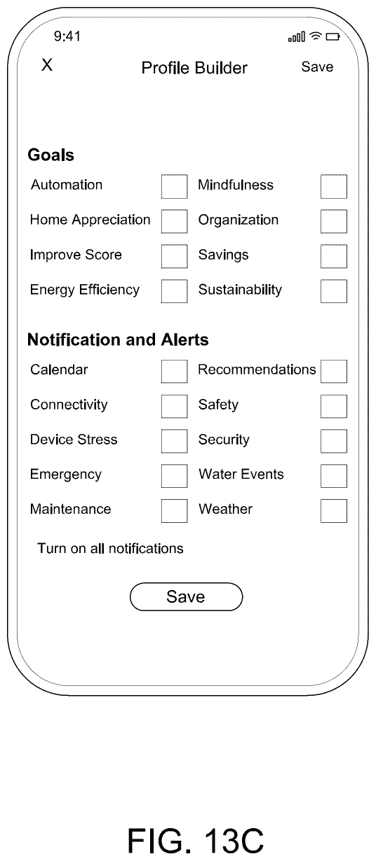

FIGS. 13A, 13B, and 13C illustrate an exemplary user interface displaying screenshots of a personalize section of the profile builder pages for the connected home ecosystem application. The profile builder may allow the user to begin tailoring their experience by selecting personal goals and setting preferences for notification types and frequency. FIG. 13A illustrates a screenshot of a personalize page for a profile builder. FIG. 13B illustrates a screenshot for a user to input personal information for the profile builder. FIG. 13C illustrates a screenshot for a user to select user preferences, such as, but not limited to, goals, notifications, and alerts.

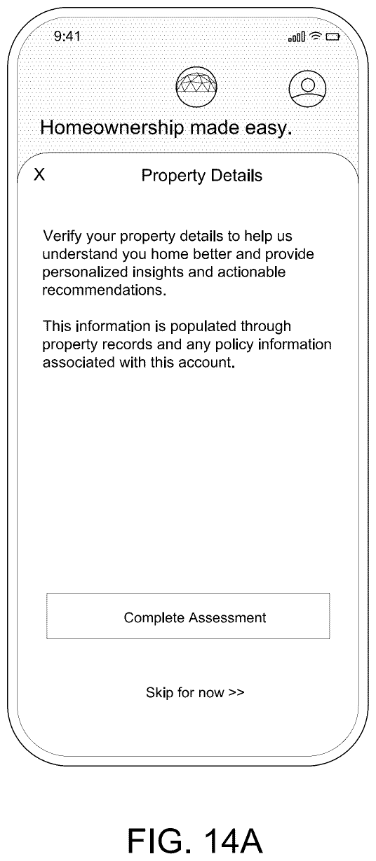

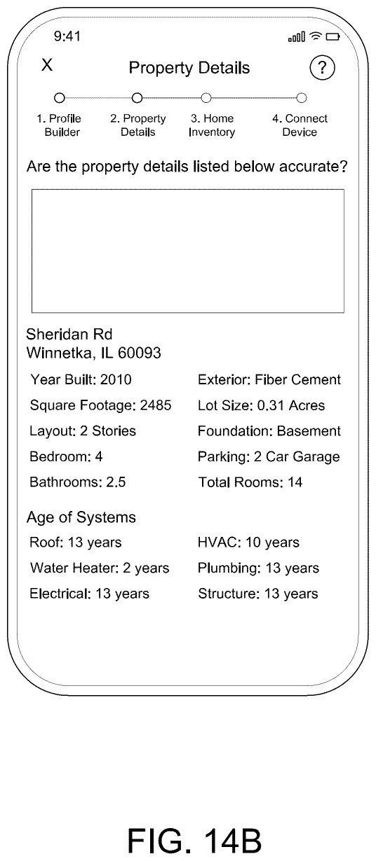

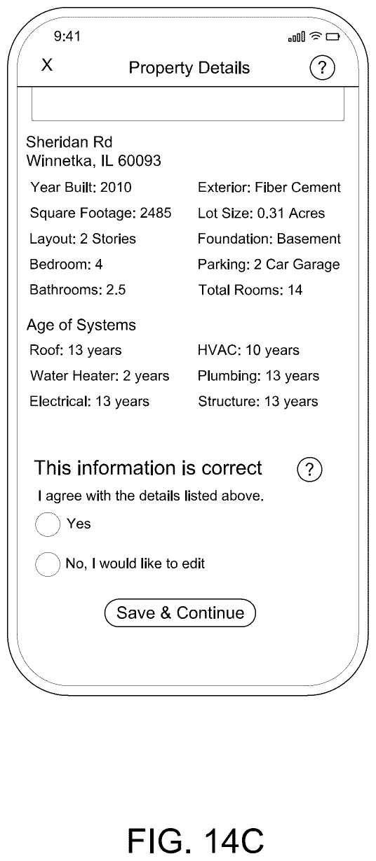

FIGS. 14A, 14B, and 14C illustrate an exemplary user interface displaying screenshots of a property details section of the profile builder pages for the connected home ecosystem application. The property details section may allow the system to pre-populate personalized data for consumers that the system already has for them. The user may be able to verify home details (e.g., square footage, siding and foundation type, number of floors, age, location, etc.). The system may pre-populate the age of systems when available. FIG. 14A illustrates a screenshot of a property details page for a profile builder. FIGS. 14B and 14C illustrate screenshots for a user to review and verify information for the profile builder.

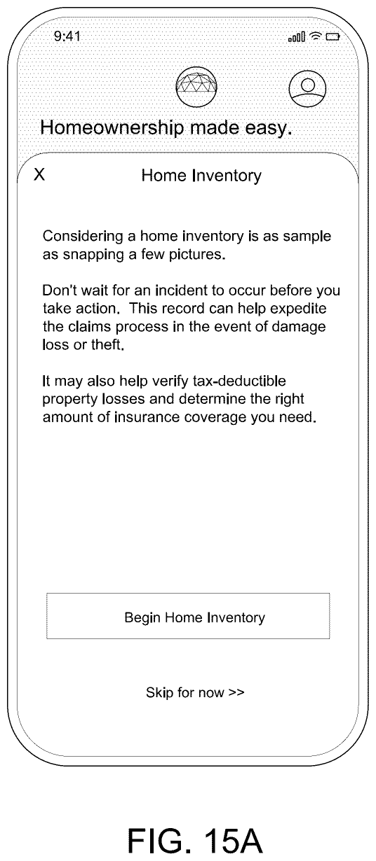

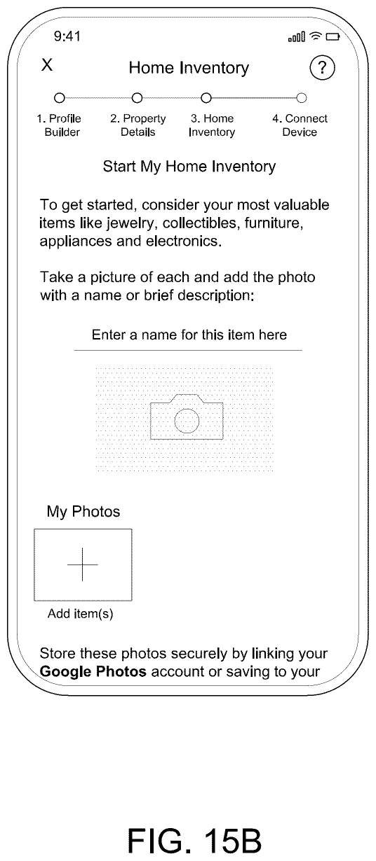

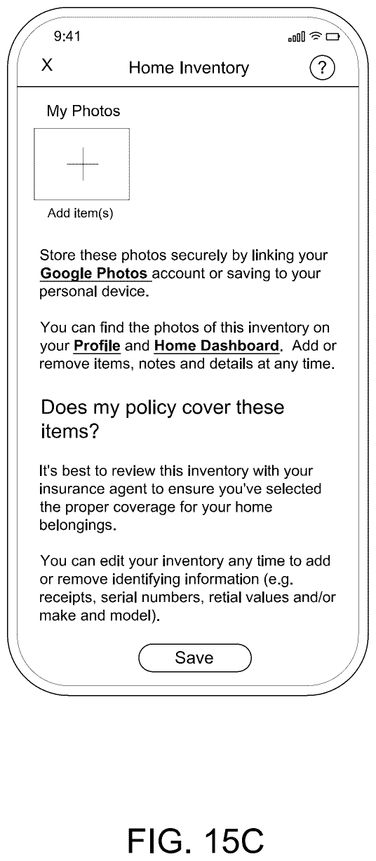

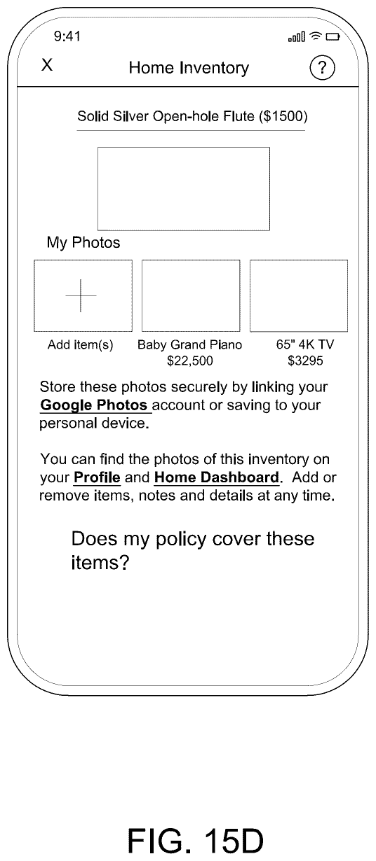

FIGS. 15A, 15B, 15C, and 15D illustrate an exemplary user interface displaying screenshots of a home inventory section of the profile builder pages for the connected home ecosystem application. The home inventory functionality provides a mechanism for consumers to capture a record of their personal possessions. The home inventory section of the connected home ecosystem application may allow user to access a camera and photos directly from the application. In some embodiments, the connected home ecosystem application may be connected to one or more photo cloud storage solutions.

FIG. 15A illustrates a screenshot of an exemplary home inventory page for a profile builder. FIGS. 15B and 15C illustrate exemplary screenshots for a user to enter items into home inventory, by letting the user capture images and enter descriptions of the items. FIG. 15D illustrate exemplary images of items that have been entered into the home inventory. The home inventory page encourages users to initially record their highest valued items. As they learn the importance and value of completing a home inventory, the user may be more likely to revisit this feature and create a detailed record. This may allow a user to create the detailed record over time.

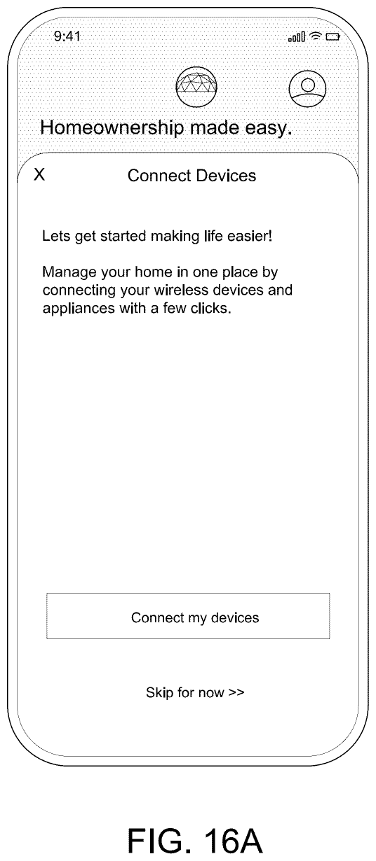

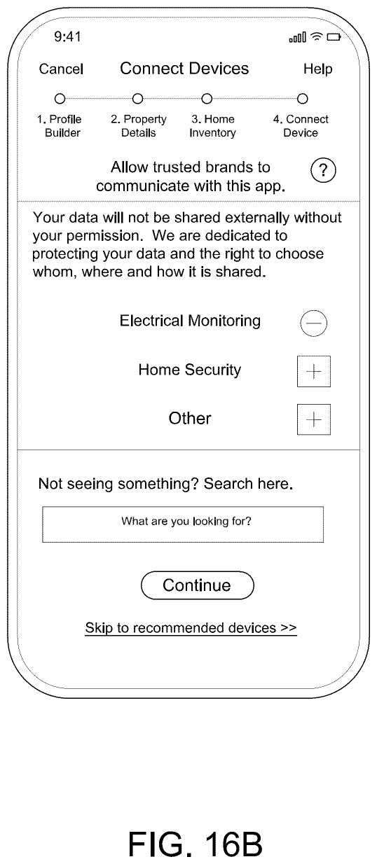

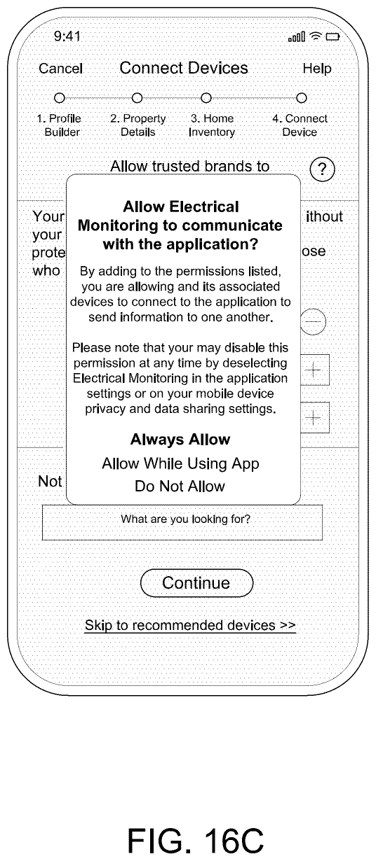

FIGS. 16A, 16B, and 16C illustrate an exemplary user interface displaying screenshots of a connected devices section of the profile builder pages for the connected home ecosystem application. The connected home ecosystem application may allow users to share smart home device data permissions with services and devices to connect between those services and the connected home ecosystem application. FIG. 16A illustrates an exemplary screenshot of a connect devices page for a profile builder. FIGS. 16B and 16C illustrate exemplary screenshots to provide and confirm connections to devices and services in the smart home.

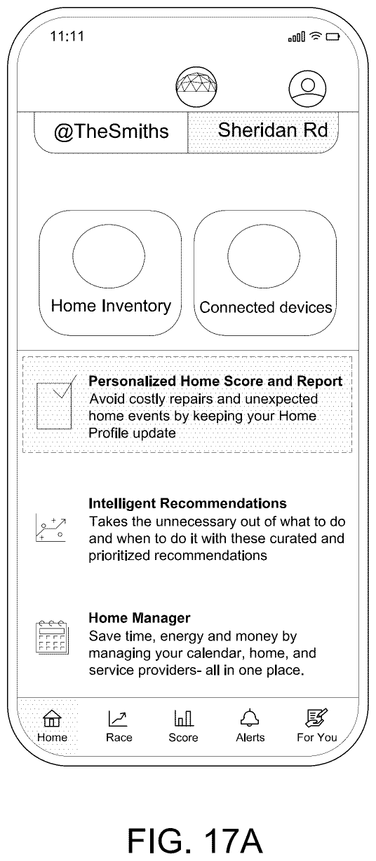

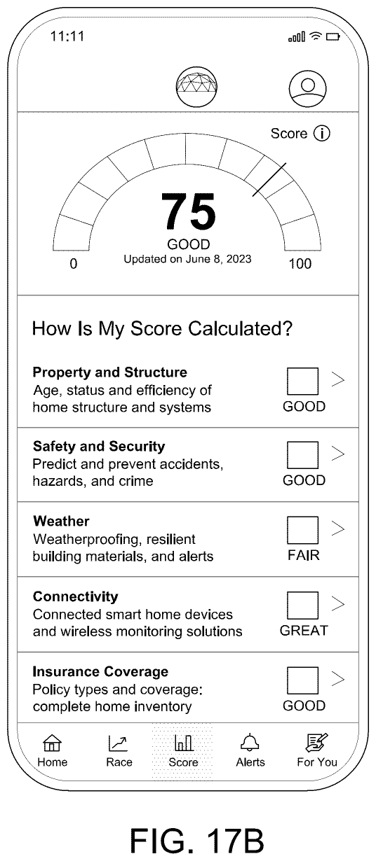

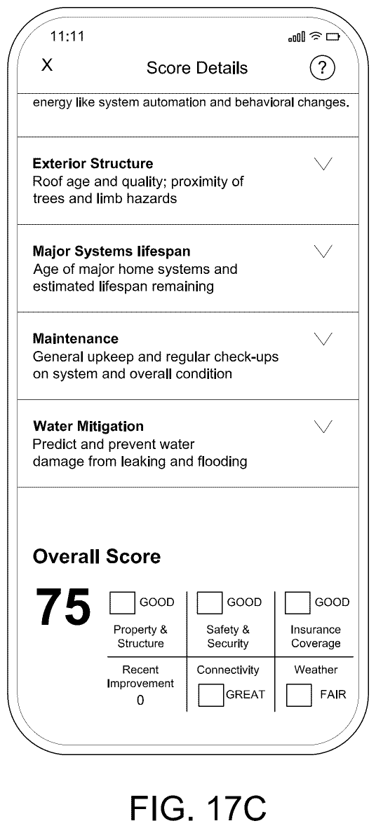

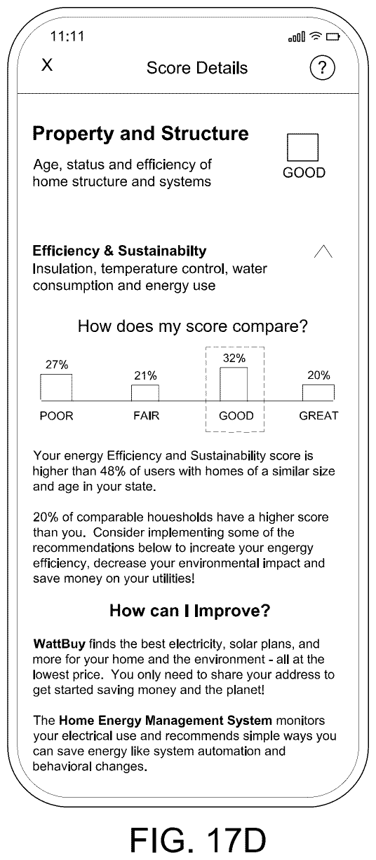

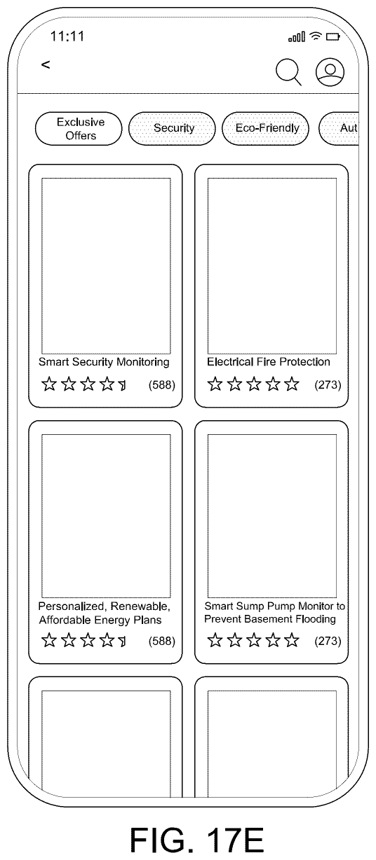

FIG. 17A illustrates a screenshot with options for a user to select to view a score, view recommendations, and/or access a home manger pages for the connected home ecosystem application. FIG. 17B illustrates an exemplary score report for the pages for the connected home ecosystem application. The connected home ecosystem application may generate a score and report after all four of the personalization widgets are completed (Personalize, Property Details, Home Inventory, and Connect Devices). Users may be provided context to understand their score, why it is valuable, and where the information is coming from. The connected home ecosystem application algorithm computes a user's score from personalization steps and the user interface displays a categorized report explaining the score components.

As shown in FIG. 17B, the home health score may be derived from a full-featured, data-based view of a property using home data, third party property characteristics data and machine learning based models. In certain embodiments, the home health score may be a calculation that uses a proprietary mix of characteristics to provide a holistic view regarding the well-being of a home. Elements about the home, as well as the surrounding environment, may be taken into consideration as part of the calculation. An aggregate score may be displayed in the home profile dashboard. The aggregate score may be calculated from various subcategories of safety and structural risks for a home based upon home and external data. The user may then drill down on specific elements and details through the dashboard.

FIG. 17C illustrates exemplary access provided to deeper levels or subcategories of the report, and may provide the user with additional details and insights. These deeper levels or subcategories may include, but are not limited to, (i) comparison to other users with similar homes; (ii) recommendations for improving the users score and overall safety and security; and/or (iii) additional subcategory details, such as, but not limited to, score comparisons, recommendations, or alerts in accordion dropdowns.

FIG. 17D illustrates exemplary personalized recommendations from the score breakdowns, as well as providing improvement recommendations. FIG. 17E illustrates an exemplary online or digital marketplace, where the user may view vendors and/or solutions to implement those recommendations. Based off their home health score, the connected home ecosystem application may present users with personalized recommendations and connect them to the marketplace. For example, a sustainability recommendation links user to exclusive offers in the marketplace.

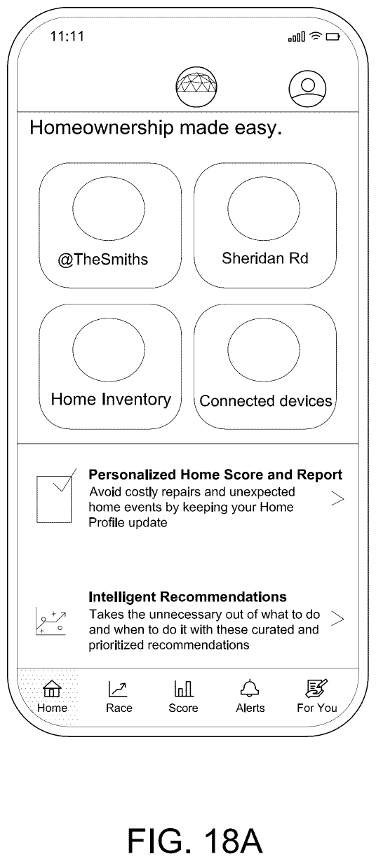

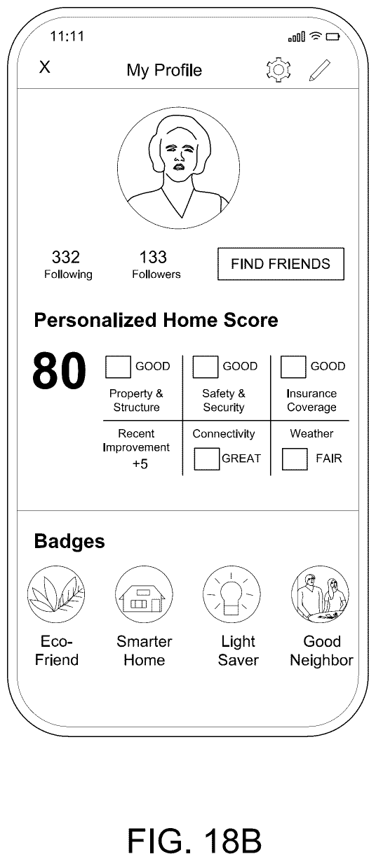

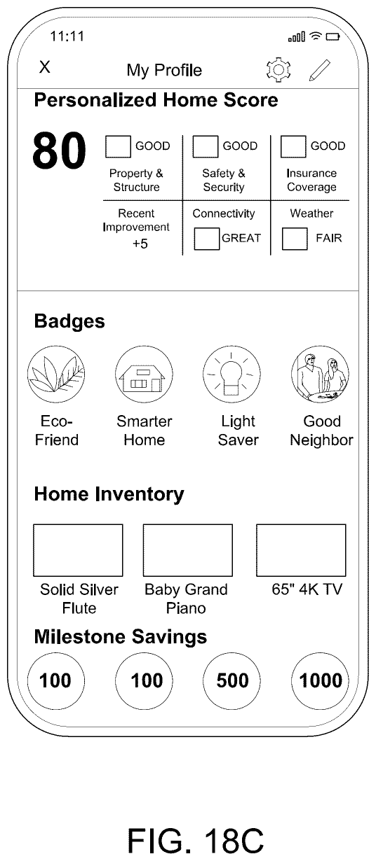

FIG. 18A illustrates an exemplary screenshot for a profile overview for the connected home ecosystem application. The profile overview may demonstrate the value of periodic or regular app engagement through: (i) social connections; (ii) score overview and improvements; (iii) earned badges; (iv) home inventory thumbnails; (v) milestone savings (e.g., lbs. of CO2, $USD, and gallons of water); (vi) communities joined; and/or (vii) other functionality, including that discussed elsewhere herein.

FIGS. 18B and 18C illustrate exemplary screenshots of profile views of a completed profile for the connected home ecosystem application.

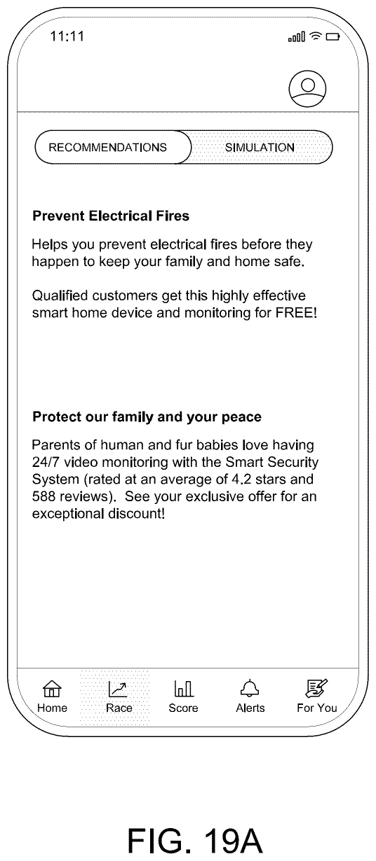

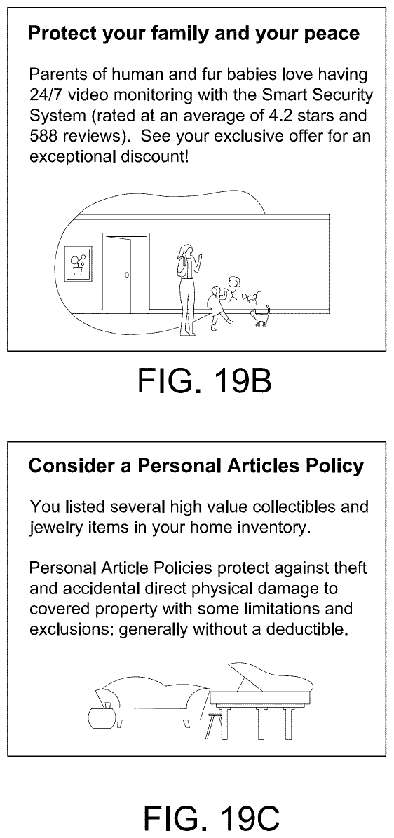

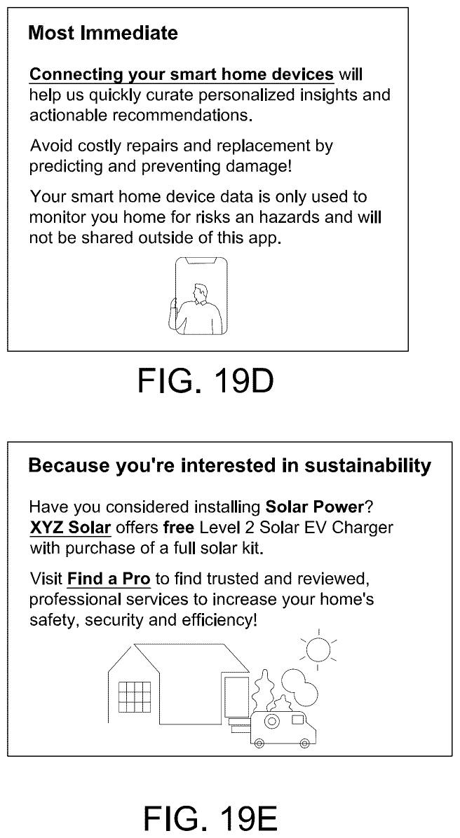

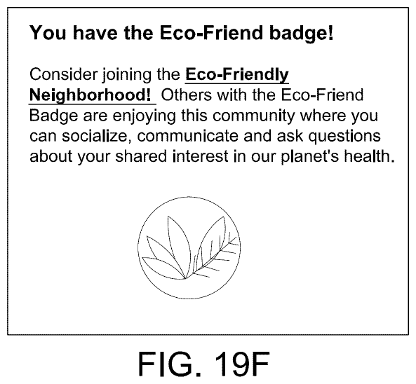

FIG. 19A illustrates an exemplary screenshot of intelligent recommendations for the connected home ecosystem application. The intelligent recommendations may be configured to take the guesswork (for homeowners or renters) out of “What to do” and “When to do it” with curated and prioritized recommendations. The intelligent recommendations are based upon product/marketplace information, the user's goals and interests, available service providers, potential and used insurance products, and current app engagement of the user. FIGS. 19B, 19C, 19D, and 19E illustrate various exemplary recommendations that may be displayed within the connected home ecosystem application. FIG. 19F illustrates an exemplary earned badge that may be displayed within the connected home ecosystem application.

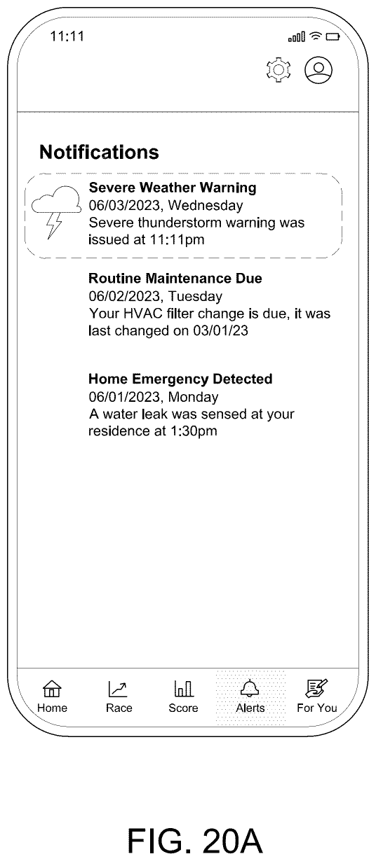

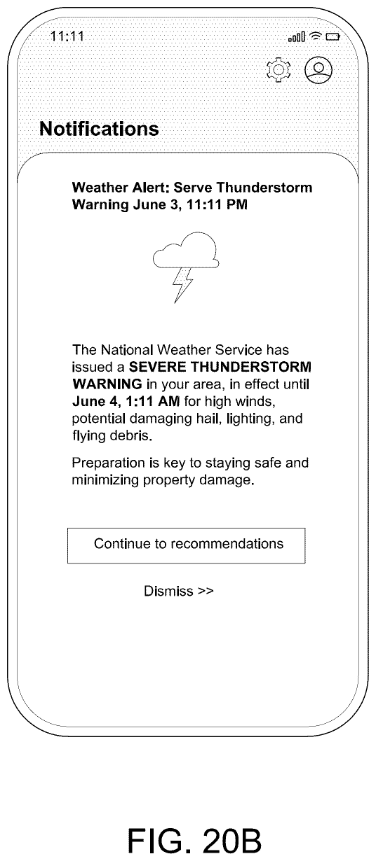

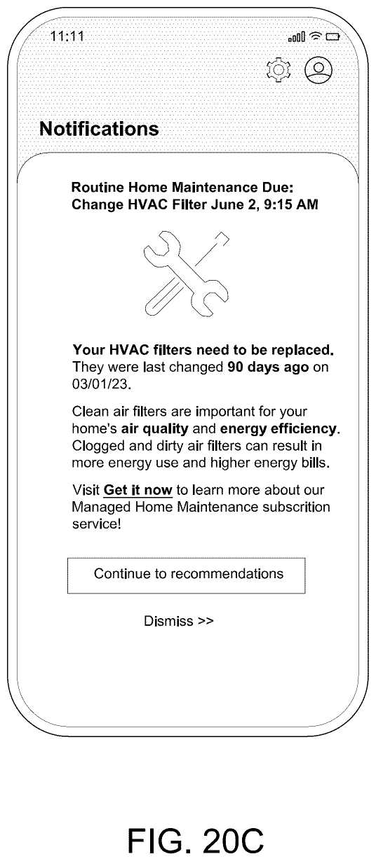

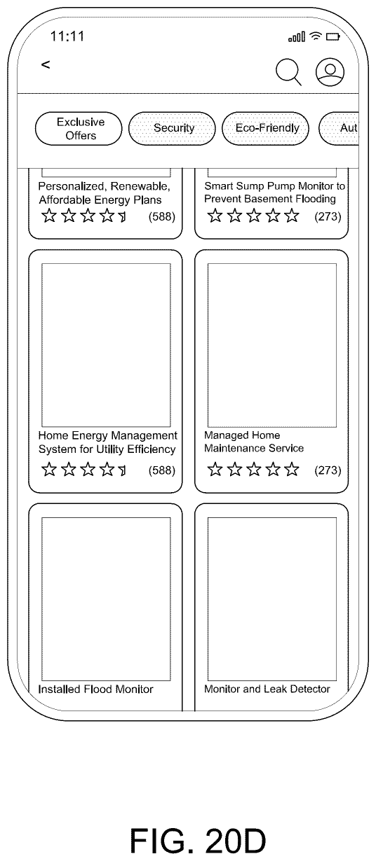

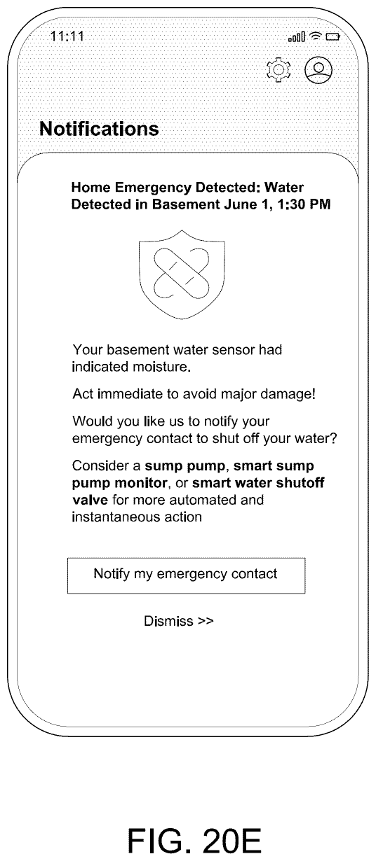

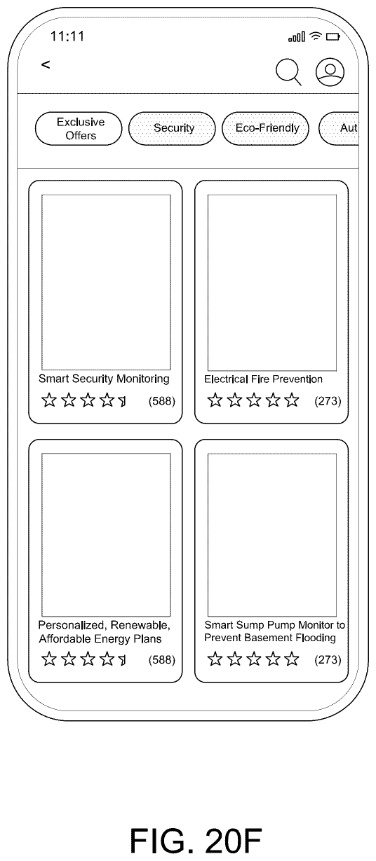

FIG. 20A illustrates an exemplary screenshot of a notifications page for the connected home ecosystem application. FIG. 20A shows exemplary notifications for a severe weather warning, routine maintenance due, and a home emergency that has been detected. FIG. 20B illustrates an exemplary weather alert provided by the connected home ecosystem application. The connected home ecosystem application provides weather warnings and preparedness notifications that are specific and personalized. The connected home ecosystem application may also provide DIY recommendations for weatherproofing and safety.

FIG. 20C illustrates an exemplary maintenance due alert, informing the user that the HVAC filters need to be replaced. The connected home ecosystem application may provide maintenance reminders including automation and calendar recommendations, as well as marketplace product and service recommendations.

FIG. 20D illustrates an exemplary online or virtual marketplace where the user may buy the HVAC filters that need to be replaced. In the exemplary embodiment, the connected home ecosystem application determines the needed size of filters and then provides a filtered view showing HVAC filters of the correct size and type.

FIGS. 20E and 20F illustrate an exemplary home emergency detected alert. In this case, the connected home ecosystem application detects that there is water in the basement. The connected home ecosystem application may also provide links to the online or digital marketplace to include devices and/or services that may correct and/or prevent this issue in the future. The connected home ecosystem application may use connected smart devices to notify user in the event a home hazard is detected (e.g., leak, fire risk, etc.). The connected home ecosystem application may provide product and service recommendations to predict hazards and prevent damage and claims.

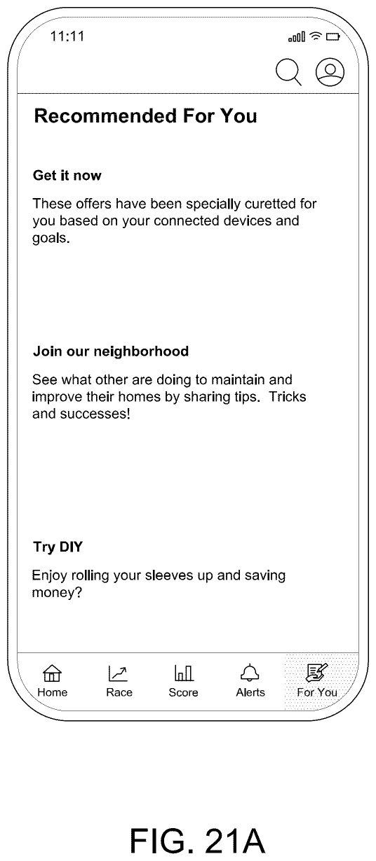

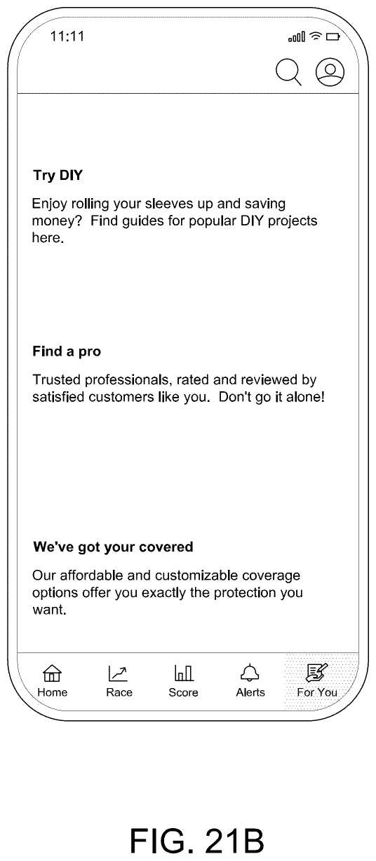

FIGS. 21A and 21B illustrate screenshots of exemplary personalized recommendations provided by the connected home ecosystem application based upon the user's information. The personalized recommendations may include content recommendations by category. Other features of the personalized recommendations include search options, online marketplace access, communities of other users, DIY (Do it yourself) advice, instructions, and encouragement, information for finding service providers, and information about potential gaps in insurance coverage.

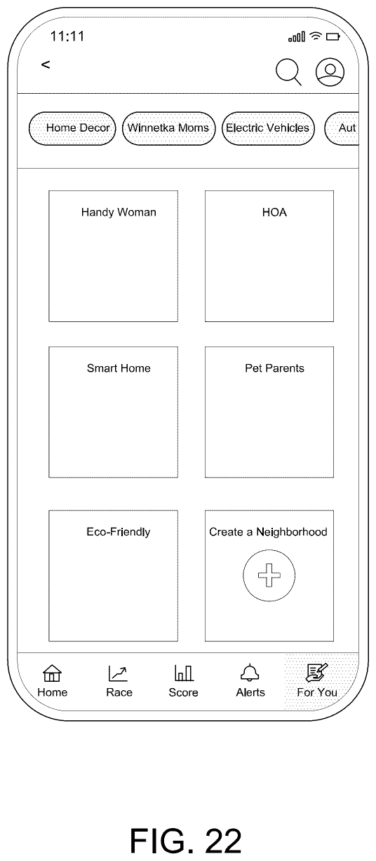

FIG. 22 illustrates an exemplary screenshot of a community page that provides the user access to one or more community features of the connected home ecosystem application. The community feature suggests social groups of users with similar homes, goals, interest, activity, recommendations, and locations. The community feature may also include the ability for users to create moderated communities.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, HMA computer system 150 is configured to implement machine learning, such that HMA computer system 150 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of home attributes with known characteristics or features. Such information may include, for example, information associated with a plurality of smart devices 110.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### Exemplary Embodiments

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: (i) receive a first element of home data from the home controller; (ii) determine a safety score for the residential property based at least in part on the first element of home data, the safety score representing a measure of safety of the residential property; (iii) receive a first element of external data from the one or more external data sources, the first element of external data relating to a geographical region of the residential property; (iv) determine a home health score for the residential property based at least in part on one or more of the first element of home data provided by the one or more smart devices and the first element of external data from the one or more external data sources, the home health score representing a measure of health of the residential property; (v) determine at least one product provider and service provider to be able to improve the home health score based at least in part upon the first element of home data and the first element of external data; and/or (vi) cause to be displayed, to a homeowner of the residential property via a graphical user interface, information about the at least one product provider and service provider to improve the home health score. The system may have additional, less, or alternate functionality, including that discussed elsewhere herein.

In yet another aspect, a computer-implemented method of evaluating and mitigating aspects of a residential property may be provided. The computer-implemented method may be performed by a computing device including at least one processor and/or associated transceiver. The method may include, via the at least one processor and/or associated transceiver: (i) receiving a first element of home data captured by one or more smart devices installed within the residential property, the first element of home data reflecting an aspect of operational quality of one or more assets of the residential property; (ii) determining a safety score for the residential property based at least in part on the first element of home data, the safety score representing a measure of safety of the residential property; (iii) receiving a second element of home data captured by the one or more smart devices; (iv) determining a home health score for the residential property based at least in part on one or more of the first element of home data and the second element of home data, the home health score representing a measure of health of the residential property; (v) determining at least one product provider and service provider to be able to improve the home health score based at least in part upon the first element of home data and the first element of external data; and/or (vi) causing to be displayed, to a homeowner of the residential property via a graphical user interface, information about the at least one product provider and service provider to improve the home health score. The method may have additional, less, or alternate actions, including that discussed elsewhere herein.

In still another aspect, a non-transitory computer readable medium having computer-executable instructions embodied thereon for evaluating aspects of health of a residential property may be provided. When executed by at least one processor and/or associated transceiver, the computer-executable instructions cause the at least one processor and/or associated transceiver to: (i) receive a first element of home data from the home controller; (ii) determine a safety score for the residential property based at least in part on the first element of home data, the safety score representing a measure of safety of the residential property; (iii) receive a first element of external data from the one or more external data sources, the first element of external data relating to a geographical region of the residential property; (iv) determine a home health score for the residential property based at least in part on one or more of the first element of home data provided by the one or more smart devices and the first element of external data from the one or more external data sources, the home health score representing a measure of health of the residential property; (v) determine at least one product provider and service provider to be able to improve the home health score based at least in part upon the first element of home data and the first element of external data; and/or (vi) cause to be displayed, to a homeowner of the residential property via a graphical user interface, information about the at least one product provider and service provider to improve the home health score. The computer readable medium may have instructions that direct additional, less, or alternate functionality, including that discussed elsewhere herein.

In yet another aspect, a computer-implemented method of evaluating and mitigating aspects of a residential property may be provided. The computer-implemented method may be implemented via one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the method may be implemented via a computer system having (i) one or more smart devices installed within the residential property; (ii) a home controller installed within the residential property, the home controller is configured to receive home data from the one or more smart devices via a home network, the home data reflecting an aspect of operational quality of one or more assets of the residential property; and/or (iii) a remote system server configured to communicate with the home controller and one or more external data sources outside the residential property via an external network. The method may be implemented via a remote system server having one or more processors, the method comprising: (1) receiving, via one or more local or remote processors and/or associated transceivers, a first element of home data from the home controller; (2) determining, via the one or more local or remote processors, a safety score for the residential property based at least in part on the first element of home data, the safety score representing a measure of safety of the residential property; (3) receiving, via the one or more local or remote processors and/or associated transceivers, a first element of external data from the one or more external data sources, the first element of external data relating to a geographical region of the residential property; (4) determining, via the one or more local or remote processors, a home health score for the residential property based at least in part on one or more of the first element of home data provided by the one or more smart devices and the first element of external data from the one or more external data sources, the home health score representing a measure of health of the residential property; (5) determining, via the one or more local or remote processors, at least one product provider and service provider to be able to improve the home health score based at least in part upon the first element of home data and the first element of external data; and/or (6) causing, via the one or more local or remote and/or associated transceivers, to be displayed, to a homeowner of the residential property via a graphical user interface, information about the at least one product provider and service provider to improve the home health score. The method may include additional, less, or alternate functionality, including that discussed elsewhere herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, NoSQL, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for evaluating and mitigating aspects of a residential property, the computer system comprising:
a home controller installed within the residential property; and
a remote system server configured to communicate with the home controller and one or more external data sources outside the residential property via an external network, the remote system server comprising one or more processors programmed to:
receive a first element of home data from the home controller;
determine a safety score for the residential property based at least in part on the first element of home data, the safety score representing a measure of safety of the residential property;
receive a first element of external data from the one or more external data sources, the first element of external data relating to a geographical region of the residential property;
determine a home health score for the residential property based at least in part on one or more of the first element of home data and the first element of external data from the one or more external data sources, the home health score representing a measure of health of the residential property;
determine at least one product provider and service provider to be able to improve the home health score based at least in part upon the first element of home data and the first element of external data; and
cause to be displayed, to a homeowner of the residential property via a graphical user interface, information about the at least one product provider and service provider to improve the home health score.

2. The computer system of claim 1 further comprising one or more smart devices installed within the residential property.

3. The computer system of claim 2, wherein the home controller is configured to receive home data from the one or more smart devices via a home network.

4. The computer system of claim 2, wherein the one or more smart devices are configured to monitor one or more attributes of the residential property.

5. The computer system of claim 4, wherein the one or more processors are further programmed to cause to be displayed, to the homeowner of the residential property via the graphical user interface, information about the one or more attributes of the residential property.

6. The computer system of claim 2, wherein the one or more smart devices are configured to control one or more systems of the residential property.

7. The computer system of claim 6, wherein the one or more processors are further programmed to:
receive, from a user device of the homeowner of the residential property, an instruction for a first smart device of the residential property; and
transmit the instruction to the home controller, wherein the home controller is configured to transmit the instruction to the first smart device, wherein the first smart device executes the instruction.

8. The computer system of claim 1, wherein the home data reflects an aspect of operational quality of one or more assets of the residential property.

9. The computer system of claim 1, wherein the one or more processors are further programmed to:
generate one or more recommendations to improve the home health score for the residential property; and
cause to be displayed, to the homeowner of the residential property via the graphical user interface, the one or more recommendations to improve the home health score for the residential property.

10. The computer system of claim 1, wherein the one or more processors are further programmed to:
receive an alert from the home controller; and
cause to be displayed, to the homeowner of the residential property via the graphical user interface, the alert.

11. The computer system of claim 10, wherein the one or more processors are further programmed to transmit the alert to a third-party server.

12. A computer-implemented method for evaluating and mitigating aspects of a residential property, the method implemented by a computer device comprising one or more processors in communication with one or more memory devices, wherein the method comprises:
receiving a first element of home data from a home controller of the residential property;
determining a safety score for the residential property based at least in part on the first element of home data, the safety score representing a measure of safety of the residential property;
receiving a first element of external data from one or more external data sources, the first element of external data relating to a geographical region of the residential property;
determining a home health score for the residential property based at least in part on one or more of the first element of home data and the first element of external data from the one or more external data sources, the home health score representing a measure of health of the residential property;
determining at least one product provider and service provider to be able to improve the home health score based at least in part upon the first element of home data and the first element of external data; and
causing to be displayed, to a homeowner of the residential property via a graphical user interface, information about the at least one product provider and service provider to improve the home health score.

13. The computer-implemented method of claim 12 further comprising one or more smart devices installed within the residential property.

14. The computer-implemented method of claim 13, wherein the home controller is configured to receive home data from the one or more smart devices via a home network.

15. The computer-implemented method of claim 13, wherein the one or more smart devices are configured to monitor one or more attributes of the residential property.

16. The computer-implemented method of claim 15 further comprising causing to be displayed, to the homeowner of the residential property via the graphical user interface, information about the one or more attributes of the residential property.

17. The computer-implemented method of claim 13, wherein the one or more smart devices are configured to control one or more systems of the residential property.

18. The computer-implemented method of claim 17 further comprising:
receiving, from a user device of the homeowner of the residential property, an instruction for a first smart device of the residential property; and
transmitting the instruction to the home controller, wherein the home controller is configured to transmit the instruction to the first smart device, wherein the first smart device executes the instruction.

19. The computer-implemented method of claim 12, wherein the home data reflects an aspect of operational quality of one or more assets of the residential property.

20. The computer-implemented method of claim 12 further comprising:
generating one or more recommendations to improve the home health score for the residential property; and
causing to be displayed, to the homeowner of the residential property via the graphical user interface, the one or more recommendations to improve the home health score for the residential property to a user device associated with the residential property.

21. At least one non-transitory computer-readable media having computer-executable instructions embodied thereon, wherein when executed by a computing device including at least one processor in communication with at least one memory device, the computer-executable instructions cause the at least one processor to:
receive a first element of home data from a home controller of a residential property;
determine a safety score for the residential property based at least in part on the first element of home data, the safety score representing a measure of safety of the residential property;
receive a first element of external data from one or more external data sources, the first element of external data relating to a geographical region of the residential property;
determine a home health score for the residential property based at least in part on one or more of the first element of home data provided by the one or more smart devices and the first element of external data from the one or more external data sources, the home health score representing a measure of health of the residential property;
determine at least one product provider and service provider to be able to improve the home health score based at least in part upon the first element of home data and the first element of external data; and
cause to be displayed, to a homeowner of the residential property via a graphical user interface, information about the at least one product provider and service provider to improve the home health score.
